(19) United States
(12) Patent Application Publication
(10) Pub. No.: US 2004/0067014 A1
(43) Pub. Date: Apr. 8, 2004

(54) Miniature optical multiplexer/de-multiplexer DWDM device, and method of aligning components thereof

(76) Inventors: Dennis R. Hollars, San Jose, CA (US); Paul T. Alexander, Morgan Hill, CA (US); Kenneth Nelson, Sunnyvale, CA (US); Randy Dorn, San Jose, CA (US)

Correspondence Address: GRAY CARY WARE & FREIDENRICH LLP, 2000 UNIVERSITY AVENUE, E. PALO ALTO, CA, 94303-2248, US

(21) Appl. No.: 10/264,379

(22) Filed: Oct. 4, 2002

(51) Int. Cl. G02B 6/32; G02B 6/293

(52) U.S. Cl. 385/33; 385/24; 385/18

(57) ABSTRACT

An optical wavelength division multiplexer and de-multiplexer device, and a method of aligning components thereof. The device includes a base plate and a series of free-space optical components including collimators, narrow band filters, and reflective mirrors mounted to the base plate. The free-space light beam is reflected off of each narrow band filter in a serial manner, whereby narrow bands of light matching the filter are focused into output optical fibers. Each component may be individually adjusted and fixed to the base plate by computer-controlled robotics, a pair of rotating servo tables, a light detector and a wavelength detector, to achieve accurate optical alignment and provide compensation among the components. Special mounting components including convex pedestals, ring support structures, concave mounting plates, and mounting blocks with through-holes are used to fix the position and angle of the various optical components.

### FIELD OF THE INVENTION

This invention relates to the field of fiber optic communication. More particularly, the invention relates to the field of optical wavelength division multiplexers and demultiplexers that are used in fiber optic communication networking systems.

### BACKGROUND OF THE INVENTION

Information is transmitted in a fiber optic communication system in the form of modulated light waves. For example, an electro-optical switch can be used to modulate a source laser beam to transform a binary electrical signal into an optical signal, which is then coupled into a fiber optical cable. The binary electrical signals can be encoded to improve the bit error rate of the information contained in the binary signal; pulse code modulation (PCM) being just one example. Since optical fibers have many advantageous signal transfer characteristics, including relatively low attenuation and high speed, they are being increasingly utilized to communicate information over large distances.

Two techniques are used to increase the amount of information that can be transferred over an optical fiber. The first technique is called time division (or time domain) multiplexing (TDM). In this technique the laser is modulated at higher and higher rates, and different signals or channels are coupled into the optical fiber in a serial fashion. This technique is limited by the rate at which the laser output can be modulated, and although the rates are being improved, there are physical limits to how high the rates can go.

A second technique is called wavelength division multiplexing (WDM). This technique takes advantage of the fact that light signals at different wavelengths or frequencies may exist simultaneously in an optical fiber with little or no interference of one signal with the others. Therefore a number of optical signals or channels, each at a different wavelength, can be simultaneously combined into one signal that is coupled into the optical fiber. Each channel requires its own laser source operating at a light frequency that is different from each of the others. Of course each individual channel may be used in a TDM mode as previously described. The device that accomplishes the combination of the different channels into one signal that can be coupled into an optical fiber is called an optical multiplexer or a “mux” device. At the other end of the optical cable, the various channels must be separated from each other before the information that they carry can be used. Often the signals are separated by an identical, or almost identical, device to the one used to combine the signals in the first place. The signals are simply sent though the same type of device “backwards”. Used in this way the device is called an optical de-multiplexer or “demux” device.

It is desirable to maximize the number of channels, each at a different wavelength, which can be simultaneously transmitted on an optical fiber in order to maximize its available bandwidth. As a consequence, increasing the number of channels crowds them closer and closer together in wavelength space. This crowding is exasperated because laser sources are not available over the entire wavelength range that the fiber optic is capable of being used, and because efficient signal amplifiers are available only in a few restricted wavelength ranges. Hence, at present optical fiber communications occupy a small percentage of the total wavelength range over which the fiber has high transmission capability. In order to use the available wavelength space more efficiently, WDM has evolved into a more crowded channel spacing architecture called DWDM, standing for dense wavelength division multiplexing. In accordance with this technique optical signals of adjacent channels differ in wavelength only slightly. As this difference becomes smaller, combining the signals at one end of the optical fiber and separating them for data recovery at the other end becomes increasing difficult, placing requirements for improved performance on mux/de-mux devices. In addition, current devices are physically rather large and bulky, and they take up a relatively large amount of the available area on a circuit board or other mounting platform. In order to reduce the cost of this technology, ways must be found to reduce its size while improving its performance.

The DWDM technique has historically been very important for the “long haul” telecommunications market, meaning traffic between cities, states, and countries (using submarine cables). The long haul networks are beginning to mature and their growth is slowing. However the local market called “metro”, or “short haul” is just now developing. Short haul networks do not have as much dependence on signal amplification as long haul networks; therefore, more of the available wavelength range can be utilized. In order to cut costs, network designers are using cheaper lasers that have poorer frequency control and thermal response. For this technique to work, the channels must be spaced further apart to avoid signal overlap during thermally induced frequency excursions. This technique is called coarse wavelength division multiplexing or CWDM. Requirements for high performance mux/de-mux devices in the CWDM arena are little eased by the wider channel spacing, because most of the channel width has to have low loss properties to accommodate the larger laser drift. This means that the wavelength separation filters or elements for the CWDM mux/de-mux devices remain about as complex to make as they are for DWDM devices.

An early technique for multiplexing and de-multiplexing a set of optical signals was disclosed by Nosu et al in U.S. Pat. No. 4,244,045, which is hereby incorporated by reference. In his FIG. 12 Nosu shows a glass substrate 60 with parallel surfaces and a series of filters mounted flush on each of the faces. A zigzag optical path at a 15-degree angle to the substrate and filter plane is created with small glass prisms 80, one attached to the substrate at the input and the rest attached to different channel filters using an index matching adhesive. At the time of its disclosure the Nosu device was difficult to assemble, and the individual parts were expensive or impossible to manufacture. For example prisms 80 were required to be identical to maintain the 15-degree optical path, and the filters, being far less sophisticated than those available today, suffered from both thermal and humidity induced wavelength drift. Nosu does note that earlier devices did not recognize the fact that difficulties in channel separation would arise for high angles of incidence at the filters because of polarization effects (S-parallel or P-perpendicular).

Scobey in U.S. Pat. No. 5,786,915 discloses an eight channel multiplexing device in which a continuously variable interference filter is deposited onto each of the opposite parallel sides of an optical block, and is hereby incorporated by reference. The device inherently suffers from low yield, since the continuously variable filters must be very accurately constructed and precisely positioned on each side of the block for the device to be useable. The double filter yield problem is avoided in an embodiment utilizing a continuously variable filter on only one side of the optical block with a uniform mirror on the other. As more demanding filter requirements have evolved, the continuously variable filter has become much more difficult to make, even on just one side.

In a second U.S. Pat. No. 5,859,717, Scobey et al abandon the concept of a continuously variable filter in favor of individual filters mounted on the optical block, which is hereby incorporated by reference. In order to eliminate the need for adhesive in the light path, the optical block has a cut out slot or gap whose height is somewhat less than the diameter of the individual filters. In FIG. 2 of the patent the optical block is element 2, the slot is element 10, and the individual filter is element 32. It is implied that the block and filters can be passively assembled with the necessary alignment accuracy, but in reality this is likely not the case, especially for DWDM applications where the channel spacing is 0.8 nm instead of the 8.0 nm example in Table A of '717. Scobey et al also address the polarization issues mentioned by Nosu and show in FIG. 1 a 3-cavity filter with S and P polarization dispersion that is adequate for telecom use at an angle of incidence (AOI) of 8 degrees. The construction details of the filter are not specified; however, filters with higher numbers of cavities can be more difficult to construct to meet polarization requirements than the illustration with only three cavities.

In U.S. Pat. No. 5,835,517 Jayaraman and Peters disclose a de-multiplexing device in which microlenses are formed on one surface of an optical substrate while a multiple set of Fabry-Perot (i.e. single cavity) filters are formed on the opposite side, which is hereby incorporated by reference. By complex vacuum deposition etching or masking operations, each filter must be individually tuned to the desired laser frequency. This expensive process produces very narrow filter band passes, which allow little tolerance for laser frequency drift. In the form described in the patent, the device is restricted to use as a de-multiplexer, and could not be used in a multiplexing mode.

U.S. Pat. No. 5,894,535 issued to Lemoff and Aronson uses the zigzag optical path concept of previous designs, but it incorporates etched waveguides instead of free space or optical block transmission of the light, which is hereby incorporated by reference. Tapered input waveguide 48 in FIG. 3 prevents the device from being reduced significantly in size. The stated vertex angle of the waveguides is between 3 and 45 degrees, but as previously mentioned, the high angles will not work because of polarization dispersion loss. One of the biggest problems with the Lemoff design is the fact that waveguides contain light propagating at a variety of angles, while the filters 45a, 45b, etc. are angle sensitive. As a consequence the filter response is rolled off or smeared toward the shorter wavelength side, preventing close spacing of the channels as is required in DWDM systems.

Grann in U.S. Pat. No. 6,201,908 B1 reveals a compact de-multiplexing device with a zigzag light path created by filters attached to one side of an optical block and a mirror provided on the other side, which is hereby incorporated by reference. It features passive alignment of the light paths through the filters with pre-molded plastic aspheric lens elements arranged in a linear array. One object of the device is to be cost effective. Details about the range of angles of the optical path are not discussed, but FIG. 7 depicts a cross-section of the optical block and with the zigzag light path through the filters. If the drawing is of uniform scale, the AOI labeled θ lies between 13 and 14 degrees. This would be far too large for a DWDM device with channel spacing of 100 GHz. The polarization dispersion loss would be unacceptable. For wider channel spacings, like CWDM, the device will work as a demultiplexer with acceptable levels of polarization dispersion loss. However, for use as a multiplexer, the molded aspheric lens array is believed to be far too inaccurate and not nearly stable enough to focus a series of source lasers back onto a single output fiber.

The majority of mux/de-mux units sold in the telecommunications market today do not use the technologies discussed above. While there are a growing number of arrayed waveguide (AWG) devices competing for market share, most mux/de-mux devices utilize individual 3-port tubular modules that can be interconnected to provide the mux or de-mux function. The tubular modules consist of accurately aligned fiber collimators and thin film filters. Fiber collimators provide the means by which light can be directed onto or out of a fiber optic. FIGS. 1A, 1B, and 1C show three types of fiber collimators that are commonly in use.

One of the earliest types of fiber collimator is illustrated in FIG. 1A. For later convenience the entire collimator is referred to as element 1, and it is made up of several individual parts beginning with the optical fiber 2. If it is a single mode fiber, optical fiber 2 consists of a central strand of glass with a diameter of about 9 microns, surrounded by a glass cladding of slightly lower optical index with a diameter of about 125 microns. The cladding is protected from nicks and scratches by a very thin polymer coating. Multi-mode fibers have larger cores and thicker cladding, but are manufactured by the same process. A color-coded jacket 3 is placed over some regions the fiber for further protection and identification. Bare fiber 2 is terminated in glass ferrule 4 where it is secured by an adhesive, and both ferrule and fiber are polished either flat or, more commonly, at an angle to reduce back reflections. In addition anti-reflection coating can be added to any of the components to further reduce reflections. A graded index lens 5 (GRIN lens) is held in position with respect to ferrule 4 by mounting and aligning each element in a glass tube 6. Elements 4 and 5 are held in glass tube 6 by adhesive 7. Great care is taken to prevent any of the adhesive from getting into the optical path. Additional metal cladding is often added over glass tube 6 to further protect the assembly. The useful working distance of the collimator depends upon the degree of parallelism of the emerging beam (indicated by arrows), which in turn depends on how precisely the components are mounted as well as on the optical quality on the GRIN lens.

A second type of collimator is shown in FIG. 1B. It is identical to the one described in FIG. 1A except for the type of lens used to collimate the light. In this collimator GRIN lens 5 in FIG. 1A is replaced by micro-aspheric lens 8. Since the curved outer surface of the lens can be given a non-spherical shape, improved optical performance can be obtained. With this type of collimator working distances in excess of 200 mm have been achieved.

A third type of collimator is shown in FIG. 1C. This collimator uses a ball lens 9 instead of a GRIN lens or an aspheric lens to create a parallel beam of light. The fiber is terminated in a glass ferrule as before, but the components generally are not mounted into tubes. Rather, they are held in V-grooves etched in single crystal silicon substrates. Because of the mature etching processes available for silicon, this type of collimator is most often used in arrays rather than as single units. The ball lenses are low in cost and many sizes are readily available; however, since they are perfectly spherical, the useful working distances are restricted by the optical defect called spherical aberration.

As previously mentioned the majority of mux/de-mux units sold in the telecommunications market today utilize an array of 3-port tubular modules. A typical prior art module 10 is illustrated schematically in FIG. 2A. It consists of two collimators 1 and 1a mounted facing each other with a thin film narrow band interference filter 11 mounted between them. The filter is physically more cubical in shape than indicated in the figure and its back surface is polished at a small angle to reduce reflections. This angle is exaggerated in the figure for clarity. Fiber collimator 1a differs from 1 and those previously discussed in that it has two fibers mounted in the glass ferrule instead of one. The elements are aligned and secured in, for instance, a V-block and then sealed into metal tube 12. The tube is typically 30 to 40 mm long and 5 to 6 mm in diameter. Rubber strain relief boots 13 at each end of the tube restrict sharp bends at the fiber to tube interface, which could cause the fiber to snap. In operation a number of light signals of wavelengths 4 are feed into one port of the module as indicated. Collimator 1a creates a parallel beam of light that is directed to filter 11. One of the light signals λ₁ is transmitted through the filter, and all the rest are reflected. Collimator 1 focuses the transmitted signal back onto an optical fiber where it emerges from the module as shown. If filter 11 is positioned properly, the reflected signals λₙ₋₁ will pass back through collimator 1a, be focused onto the second optical fiber in the ferrule, and exit the module. This 3-port module has become a standard of the communications industry; however, the performance of each device depends very crucially upon accurate optical alignment, and that alignment not changing with temperature or other environmental conditions. Excessive insertion losses are not uncommon with typical production yields running less than 50%.

A typical prior art mux/de-mux device is built up by cascading a number of 3-port modules. This architecture is depicted in FIG. 2B using an eight channel device for illustration. Each 3-port module is identical except for the pass band of the filter. Filter 11a passes only channel 1, filter 11b passes only channel 2, and so on for all eight channels. The λₙ₋₁ output from the first module becomes the input to the second module. The λₙ₋₂ output from the second module is the input to the third module, and so forth for the remaining modules. The modules are mounted into a box and fiber-to-fiber splices are made to connect the modules together in the indicated cascade fashion. The fiber splices are rarely perfect, leading to another source of insertion loss and device degradation. The box has openings in its side for the eight output fibers, the input fiber, and (optionally) a pass through fiber. All these ports are typically arrayed along one side of the box, and it is sealed around its edges and around the fibers to make it more impervious to environmental changes. Strain relief boots help to protect the fibers from breakage due to accidental sharp bends. The size of the box used to house the mux/de-mux device is significantly larger than the size of the individual modules. The size is determined primarily by the allowable bend radius (approximately 2 inches) the fiber can tolerate before signal loss becomes excessive. The typical size for an eight channel device is approximately 4 by 6 inches by 0.5 inches thick. Mux/de-mux devices having sixteen or more channels are only slightly larger, fiber management still being the major issue.

What is needed is a highly efficient mux/de-mux device that is smaller and more economical than current devices. A smaller format would result from the elimination of internal fiber management and fiber-to-fiber splices between the wavelength selective elements, as well as a reduction in the number of components required for each channel. A smaller format device would occupy less space on circuit boards thus helping to reduce both the size and cost of optical networks.

### SUMMARY OF THE INVENTION

One of the features of the present invention is to provide a miniature optical mux/de-mux device for fiber optic communication systems, which will operate with either single-mode or multimode fiber optic cables.

Another feature of the present invention is to minimize optical losses at all component interfaces to produce a highly efficient device with better optical performance than current devices.

A further feature of the present invention is to provide a device with fewer components per channel than current devices in order to reduce the cost of the device.

Yet another feature of the present invention includes a novel design for the mux/de-mux device, which can be constructed by computer controlled robotic assembly to reduce labor costs.

Still another feature of the present invention is a simplified sealing system and mounting container, which thermally isolates the device and provides improved environmental protection.

One further feature of the present invention is to provide an improved mounting scheme, method and apparatus for the optical components in the miniature optical mux/de-mux device.

Described below is the design and construction details of a miniature mux/de-mux, DWDM or CWDM device. Two embodiments of the design are discussed, one has a radial format and the other has a linear format; however, the operating principles of each are identical. The basic device is described using an eight-channel format as an example, but a fewer or greater number of channels are easily accommodated. Additionally, two or more of the devices may be linked together to provide additional channels either at initial installation or to expand the number of channels at a later date.

The present invention is an optical wavelength multiplexer and de-multiplexer device that includes a base plate having a surface, a first optical collimator for receiving multiwavelength light and producing a substantially collimated free-space beam of the light over the base plate surface, a plurality of support structures mounted to the base plate, a plurality of first pedestals each having a curved bottom surface mounted to one of the support structures, a plurality of optical filters each mounted to one of the first pedestals for receiving the light beam, for transmitting any portion of the received light beam within a predetermined wavelength range, and for reflecting the untransmitted portion of the received light beam to another of the optical filters, a plurality of mounting plates mounted to the base plate surface and each having a curved top surface, and a plurality of optical collimators each for focusing one of the transmitted portions of the light beam from one of the optical filters into one of a plurality of output optical fibers, wherein each of the optical collimators is mounted over one of the mounting plate top surfaces.

In another aspect of the present invention is a method of mounting a plurality of mirrors, a plurality of filters and a plurality of collimators having predetermined nominal positions on a base plate to create an optical wavelength multiplexer and de-multiplexer device. The method includes the steps of passing light through a first collimator to produce a substantially collimated free-space beam of the light, mounting the first collimator on the base plate so the light beam is directed to a nominal position of one of the mirrors, mounting each of the mirrors onto the base plate for receiving the light beam and for reflecting the light beam to a nominal position of one of the filters, mounting each of the filters onto the base plate for receiving the light beam, for transmitting any portion of the received light beam within a predetermined wavelength range, and for reflecting the untransmitted portion of the received light beam to a nominal position one of the mirrors, and mounting each of the collimators adjacent to one of the mounted filters for receiving the transmitted light beam portion therefrom.

Other objects and features of the present invention will become apparent by a review of the specification, claims and appended figures.

### BRIEF DESCRIPTION OF THE DRAWINGS

FIG. 1A shows the construction of a conventional fiber optic collimator using a graded index (GRIN) lens.

FIG. 1B shows the construction of a conventional fiber optic collimator using a micro-aspheric lens.

FIG. 1C shows the construction of a conventional fiber optic collimator using a ball lens.

FIG. 2A shows a conventional 3-port module for separating one optical signal from an input containing a number of optical signals.

FIG. 2B shows a conventional 8-channel mux/de-mux architecture using a cascade of 3-port modules to successively separate individual optical signals from a plurality of input optical signals.

FIG. 3A shows a three-dimensional view of the basic radial embodiment of the present invention. The protective container is not shown.

FIG. 3B shows a three-dimensional view of the basic linear embodiment of the present invention. The protective container is not shown.

FIG. 4A is a plan view of the radial embodiment of the present invention showing the optical path and the positions of the optical components.

FIG. 4B is a plan view of the linear embodiment of the present invention showing the optical path and the positions of the optical components.

FIG. 5A is a plan view of the radial embodiment of the present invention showing a design variation for increasing the number of channels in the device.

FIG. 5B is a plan view of the linear embodiment of the present invention showing a design variation for increasing the number of channels to 16 in the device.

FIG. 6A is a plan view of the linear embodiment on the present invention showing a design variation for an 8-channel device.

FIG. 6B is a plan view of an add/drop device based on the linear architecture.

FIG. 7A is a plan view of the radial embodiment showing how channel count can be increased through serial connection.

FIG. 7B is a plan view of the radial embodiment showing how channel count can be increased by connection through band splitting filters.

FIG. 7C is a plan view of the radial embodiment showing how channel count can be increased by connection through skip or band isolating filters.

FIG. 8A is the theoretical transmission curve for a 100 GHz multi-cavity thin-film filter according to design A at an angle of incidence of 0 degrees.

FIG. 8B is the theoretical transmission curve for a 100 GHz multi-cavity thin-film filter according to design B at an angle of incidence of 0 degrees.

FIG. 9A is the theoretical transmission curves for the S and P polarization components of a 100 GHz multi-cavity thin-film filter according to design A at an angle of incidence of 10 degrees.

FIG. 9B is the theoretical transmission curves for the S and P polarization components of a 100 GHz multi-cavity thin-film filter according to design B at an angle of incidence of 10 degrees.

FIG. 10 shows the difference in transmission between the S and P polarization components of a 100 GHz multi-cavity thin-film filter according to design A for angles of incidence between 0 and 10 degrees.

FIG. 11 is a cross-sectional schematic view of the radial or linear device with the cross section taken approximately along the light path from a mirror to a filter and into a collimator.

FIG. 12A is an enlarged cross-sectional schematic showing the normal curvature of a filter and mirror caused by intrinsic stress in the coating.

FIG. 12B is an enlarged cross-sectional schematic showing the preferred method of compensating the effects of normal curvature by coating the mirror on its rear surface.

FIG. 12C is an enlarged cross-sectional schematic showing an alternative method of compensating the effects of normal curvature by identical coatings on each side of the filters and mirrors.

FIG. 13A is a plan view showing the bottom protective housing for the radial device.

FIG. 13B is a plan view showing the top protective housing for the radial device.

FIG. 14A is a plan view showing the bottom protective housing for the linear device.

FIG. 14B is a plan view showing the top protective housing for the linear device.

FIG. 15A shows the radial device assembled into the bottom protective housing.

FIG. 15B shows the linear device assembled into the bottom protective housing.

FIG. 16 is a cross-sectional schematic view of the fully assembled radial or linear device.

FIG. 17 is a side cross-sectional view of an alternate component mounting scheme used in the radial device.

FIG. 18A is a top plan view showing the base plate and optical component layout for the alternative component mounting scheme as used in the radial device.

FIG. 18B is an expanded top plan view showing the base plate and optical component layout for the alternative component mounting scheme as used in the radial device.

FIG. 19 is a plan view of a robotic assembly system for the radial embodiment of the present invention.

FIG. 20A is an isometric schematic view of the robotic alignment of the input collimator for the radial embodiment of the present invention.

FIG. 20B is an isometric schematic view of the robotic alignment of a mirror for the radial embodiment of the present invention.

FIG. 20C is an isometric schematic view of the robotic alignment of a filter for the radial embodiment of the present invention.

FIG. 20D is an isometric schematic view of the robotic alignment of an output collimator for the radial embodiment of the present invention.

FIG. 21 is a side cross-sectional view of the alternate component mounting scheme used in the radial device, with solid curved mounting surfaces.

FIG. 22 is a side cross-sectional view of the alternate component mounting scheme used in the radial device, with different curvature directions.

### DETAILED DESCRIPTION OF THE PREFERRED EMBODIMENTS

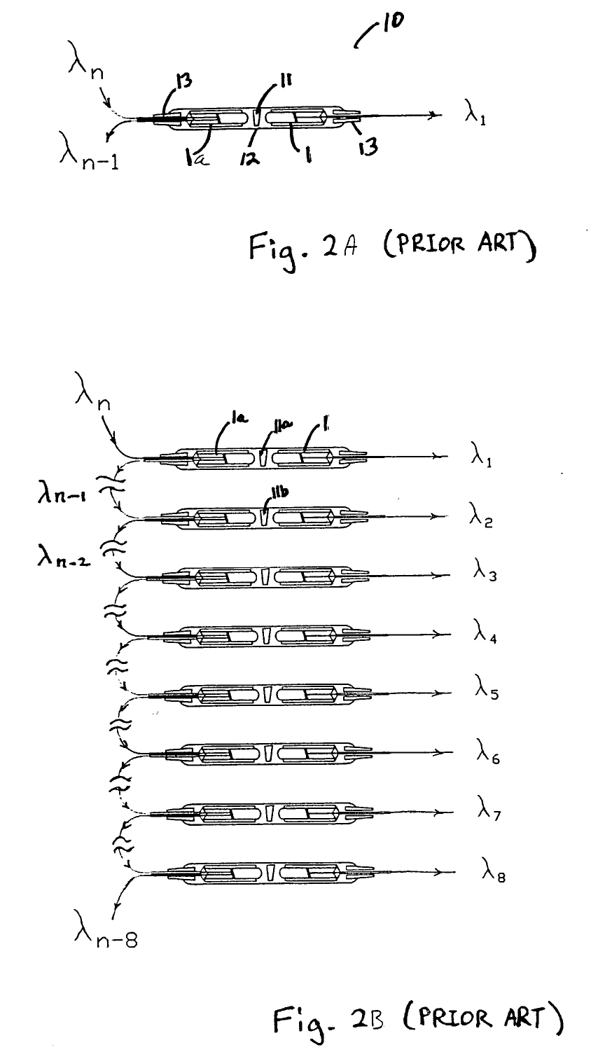

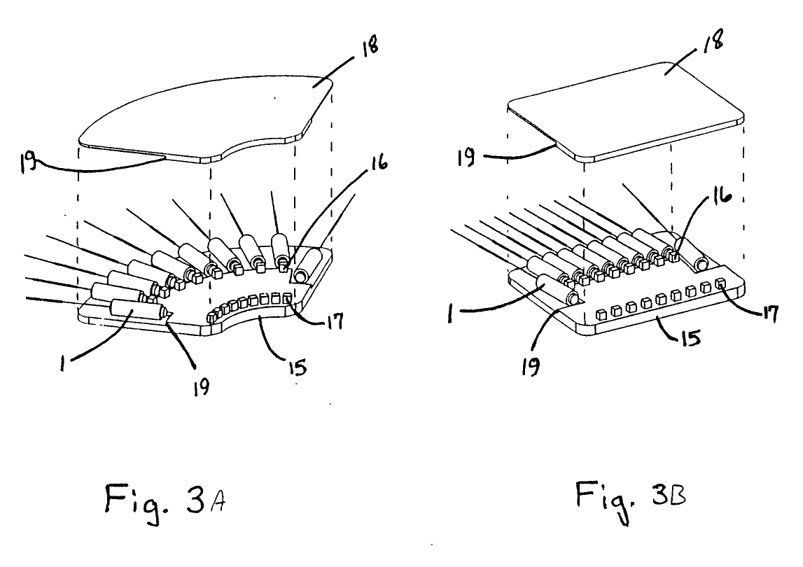

FIGS. 3A and 3B are three-dimensional views of the two basic embodiments of the present invention. Neither view shows the container into which the device is later sealed to provide both environmental protection, and a means to mount the device to a circuit board or other optical network platform. The container will be discussed after the core optical concepts are described. FIG. 3A illustrates the radial embodiment, while FIG. 3B illustrates the linear embodiment. Throughout this description it is primarily an 8-channel device that is used for purposes of illustration; however, those skilled in the art will readily understand how the basic geometry can be adapted for either a fewer or a greater number of channels. For example, the radial format in FIG. 3A subtends a 90-degree angular section of a circular annulus, but the angular section for a 4-channel device would subtend a smaller angle while a 16-channel device would require a larger angle. Similarly, the linear device in FIG. 3B would be shorter for fewer channels and longer for a greater number of channels. If reduced to just two channels, the linear embodiment might be more practical than the radial, since the mounting would become cumbersome. As a 2-channel embodiment, it would become a device to add or drop a channel (add/drop) to or from a signal stream. The functional principles are identical for either embodiment, only the format (radial or linear) differs to accommodate variations in available components and filter performance. One can consider the linear format to be simply the limit of the radial format at an infinite radius.

The description below includes numerical values for the component design, orientation and size of the preferred embodiments of the present invention, which were obtained by reducing the preferred embodiments to practice. However, it should be understood that these numerical values are included as examples only, and do not limit the scope of the invention.

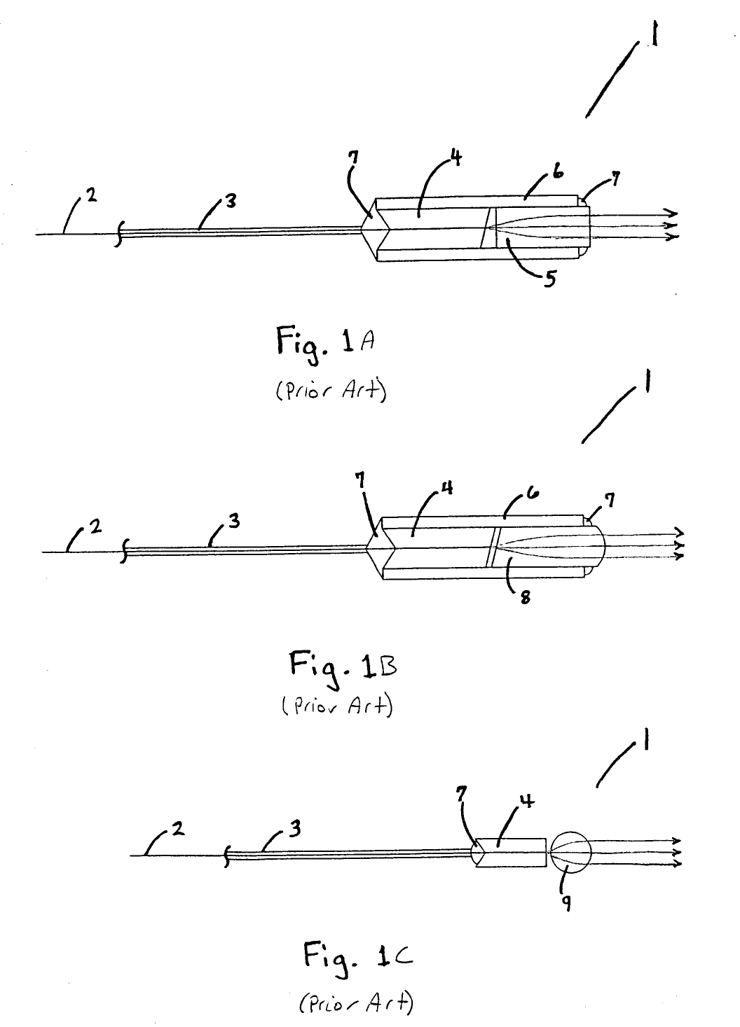

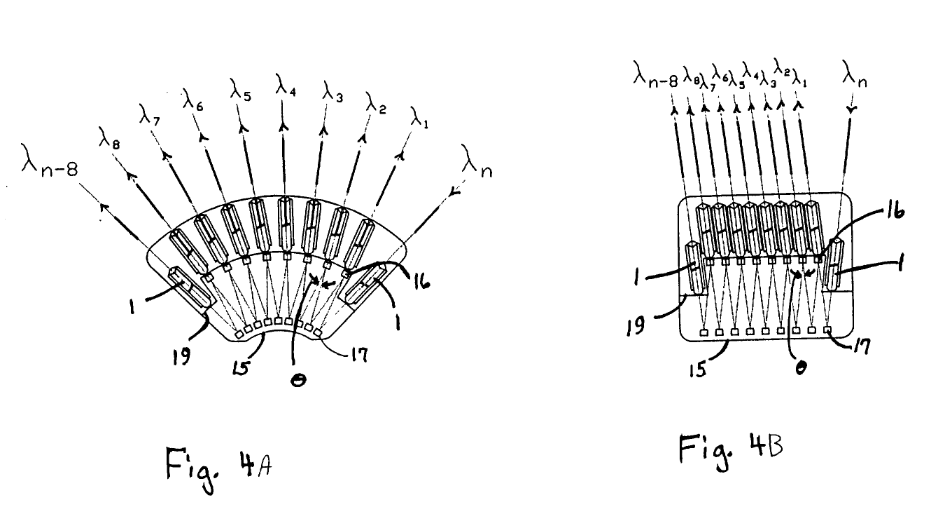

Each embodiment has a base plate 15 with at least a flat upper surface that serves as a miniature optical bench. Its thickness is selected for stability depending on the material used. For example, a typical thickness for glass or silicon is 3 to 4 mm. Fiber optic collimators 1, multi-cavity thin-film filters 16 and thin-film high reflectivity dielectric mirrors 17 are mounted on plate 15 using adhesives that are compatible with the physical properties of the materials. Fiber optic collimators 1 can be any of the three fiber collimators illustrated in FIGS. 1A, 1B or 1C, or any other optical device that collimates the optical output of an optical fiber (and focuses collimated light into an optical fiber in a reverse direction). Filters 16 are industry standard Fabry-Perot multi-cavity type coated optics, made of alternating layers of transparent high and low index dielectric materials formed on a transparent substrate. Cavities are formed by the inclusion of transparent layers of material. Mirrors 17 are similarly well known optics made of alternating layers of transparent high and low index dielectric materials mounted on a substrate, but contain no cavities. While a silver or gold mirror would work in this application, the reflection therefrom is somewhat inferior to the dielectric mirror described above. In the radial embodiment shown in FIG. 4A, the filters 16 (along with the collimator 1) and the mirrors 17 are disposed in opposing arcuate patterns of differing radii of curvature. In the linear embodiment shown in FIG. 4B, the filters 16 (along with the collimator 1) and the mirrors 17 are disposed in opposing columns.

Top plate 18 is secured to the top of each optical component by an adhesive in similar fashion to the way they are attached to the base plate. The top plate is thinner than the base plate to minimize the overall device thickness, but it is thick enough to provide a sandwiched structure that is resistant to shock and vibration. Typically its thickness is about 1 mm for glass or silicon. In general both the base plate and the top plate can have a ledge or step 19 which is sized to bring the axes of the particular fiber collimators in line with the centers of the filters and mirrors. If the diameters of the collimators and the heights of the filters and mirrors are equal, step 19 can be eliminated. If the collimators were smaller in diameter than the filter dimension (opposite to that shown in the figures), then step 19 would be in the opposite sense.

Invariably there are trade-offs that must be made between minor variations in the design and their impact on the cost. For example, if the diameter of the optimum collimator that is available is greater than the height of a standard filter, one could either create the step in the base and top plates or increase the size of the filter. Since each filter is expensive, and increasing its size increases both its cost and the total thickness of the device, the more cost effective approach is to create the step in the plates. In addition, if adhesive in the optical path could be tolerated for low laser power systems, then filters 16 could be attached directly to the end of collimators 1. GRIN type collimators would serve best for this purpose since their ends are flat. This would have the advantage of being a pre-assembled part, but GRIN type collimators can be more expensive, and adhesive in the optical path is not broadly acceptable.

FIGS. 4A and 4B are schematic plan views of the radial and linear embodiments of the device showing the base plates with the layout of the optical components and the light paths through each device. The top plates seen in the previous figures are not shown. Elements common to previous drawings are labeled with consistent numerical designations. Arrows on the fibers indicate an input of λₙ signals from an incoming fiber optic cable that are formed into a parallel beam by a first optical collimator 1. Subsequently mirrors 17 and filters 16 reflect the parallel beam through the device in a linear or arcuate zigzag pattern with eight of the n input channels being separated out (de-muxed), each separated channel being refocused back onto an output fiber optic cable by another optical collimator 1. If the arrows were each turned around, it would indicate eight different laser signals being combined or muxed onto a single optical fiber. A last port, λₙ₋₈, can be used, if required, to pass unused channels through the device for use elsewhere. In general the same device can be used in either direction depending upon which way it is hooked up. For purposes of simplification the de-mux form of the device is used in this description. In addition, the radial format is described as a 90-degree segment, but as explained before that is not an essential feature of the design, although it is a possible convenience for mounting in the corner of a circuit board.

The radial and linear devices in FIGS. 4A and 4B respectively are shown at the same relative linear scale to facilitate direct comparison. The actual length of an 8 channel linear device is approximately 1.5 inches. Each device is illustrated using exactly the same components, so the differences and relative advantages of the formats can be compared. If, for the same number of channels, one requires the total length of the optical path to be approximately the same in each format (from the input fiber collimator at λₙ through the “hall of mirrors” to the output pass through collimator at λₙ₋₈), then the input collimators are identical and have the same working distance in each format. As mentioned earlier, fiber collimators are becoming commercially available with working distances in the range of 200 mm and with diameters below 3 mm. They will become smaller as the state of the technology advances, enabling the size of the present devices to be reduced further. Given these constraints, it should be apparent from the figures that the radial embodiment is limited in its size by the crowding together of high reflection mirrors 17 along their mounting arc, while the linear embodiment becomes limited by the crowding together of fiber collimators 1. The linear format has the advantage of somewhat smaller size, but the radial format allows more working room for collimator alignment and it has a smaller angle of incidence (AOI) of the beam at filters 16. The angle θ in the radial format is 10.8 degrees, while θ in the linear format is 14 degrees. The AOI of the beam is half of each angle, or 5.4 degrees in the radial format and 7 degrees in the linear format. A smaller AOI is advantageous from the standpoint of filter design, as will be discussed below.

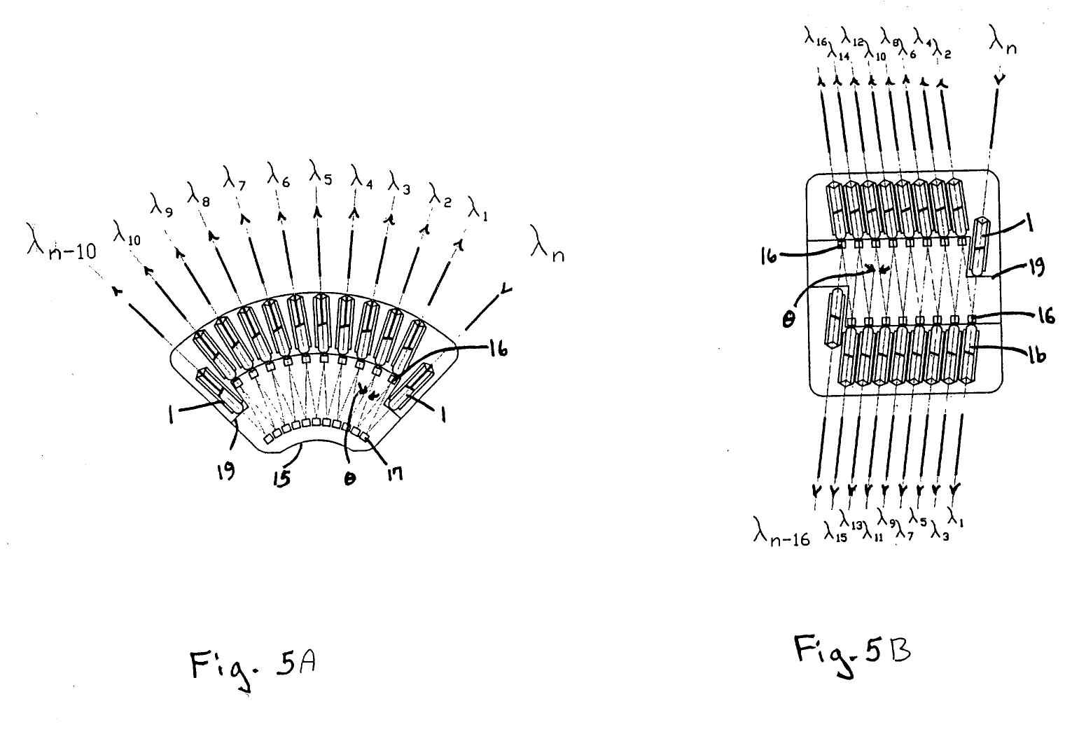

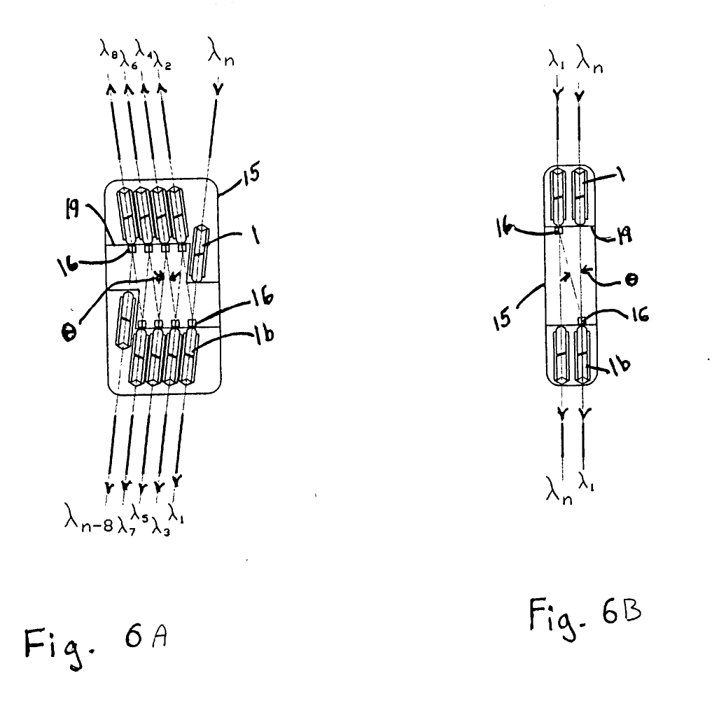

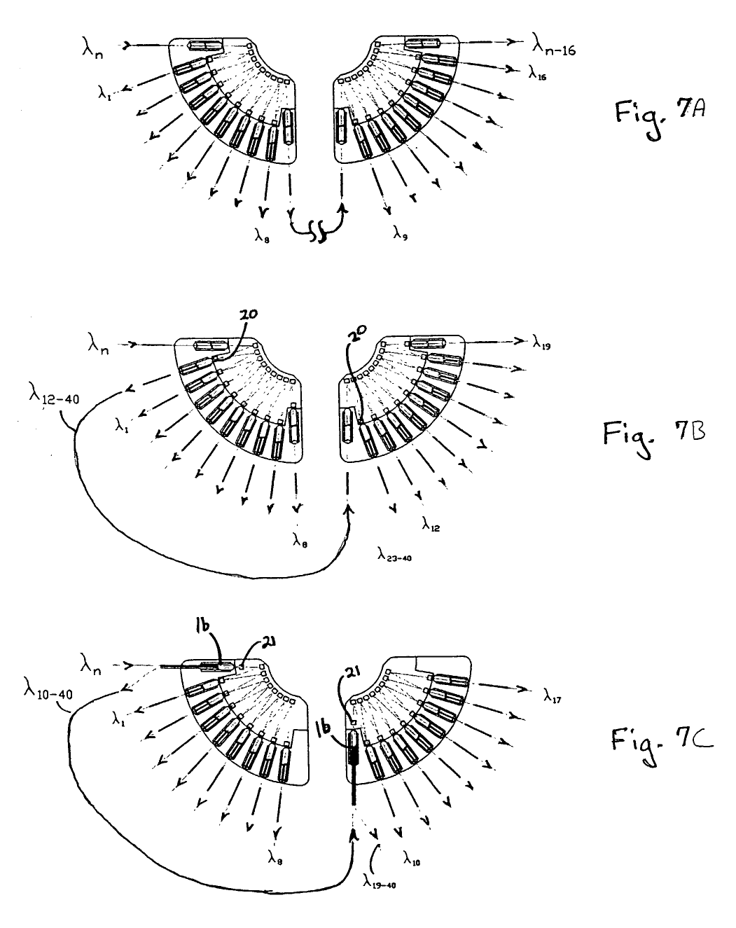

FIG. 5A illustrates the design variation caused by increasing the channel count from eight to ten in the radial format while keeping the same base plate as that shown in FIG. 4A. Collimators 1 and filters 16 are closer together than in the 8-channel case, but there is still adequate space to allow robotic manipulation and alignment of the components for manufacturing the device. Keeping the AOI the same as before (angle θ equal to 10.4 degrees) requires that mirrors 17 be aligned along an arc of slightly larger radius. The longer arc still does not accommodate the room needed for the two extra mirrors for the additional two channels, so the mirror crowding becomes worse. If more channels were added in the same footprint, the mirrors would first touch and then either overlap or have to be made smaller. It is probably more cost effective to avoid customized sizes of the optical components, and adjust the footprint of base plate 15 to accommodate devices with different channel counts. The component layout formats shown in FIGS. 4A and 4B are deemed to be a good compromise between standard component sizes, design flexibility, and the requirements for robotically controlled alignment.

One way to increase the channel count in the linear format is simply to make it longer and add collimators at the same spacing as shown in FIG. 4B. For example a 16-channel device would be a little less than twice as long as the 8-channel device, but the last channel would suffer the combined reflection loss from sixteen mirrors and fifteen filters. This creates a larger difference in signal strength between the first and the last channel for the 16-channel device compared to the 8-channel device. Some of the signal difference can be avoided by the design shown in FIG. 5B. This 16-channel layout avoids the loss from the mirror reflections by replacing the mirrors 17 in FIG. 4B with filters 16, and adding collimators 1b for the extra eight channels. For mirrors with 99.5% reflection, the reduction in signal variation across the sixteen channels is about 0.35 db. Angle θ remains the same at 14 degrees (AOI of 7 degrees). This layout results in the odd numbered channels being de-muxed on one side of the device, and the even channels de-muxed on the other side of the device. An advantage of this layout is that the same collimator working distance can now serves sixteen channels instead of eight. Possible disadvantages are its departure from the current architecture of having all of the ports on one side, and the loss of a degree of freedom in alignment that may improve production yields. Of course one could restore all of the output fibers to the same side of the container by bending the eight outputs on one side around to the other side. While this would increase the size of the container, it would still reduce costs and improve performance when compared to current technology. Because filters become better reflectors at wavelengths further from their pass bands, the difference in signal loss between the channels is minimized by de-muxing the channels in wavelength (or frequency) order.

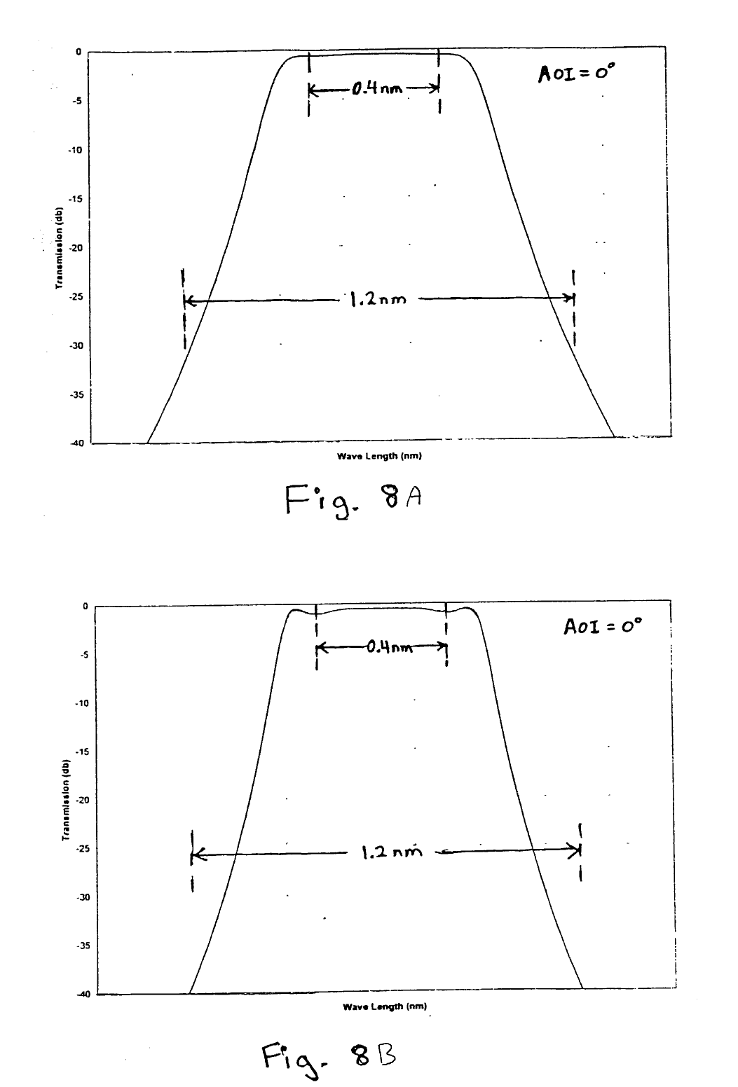

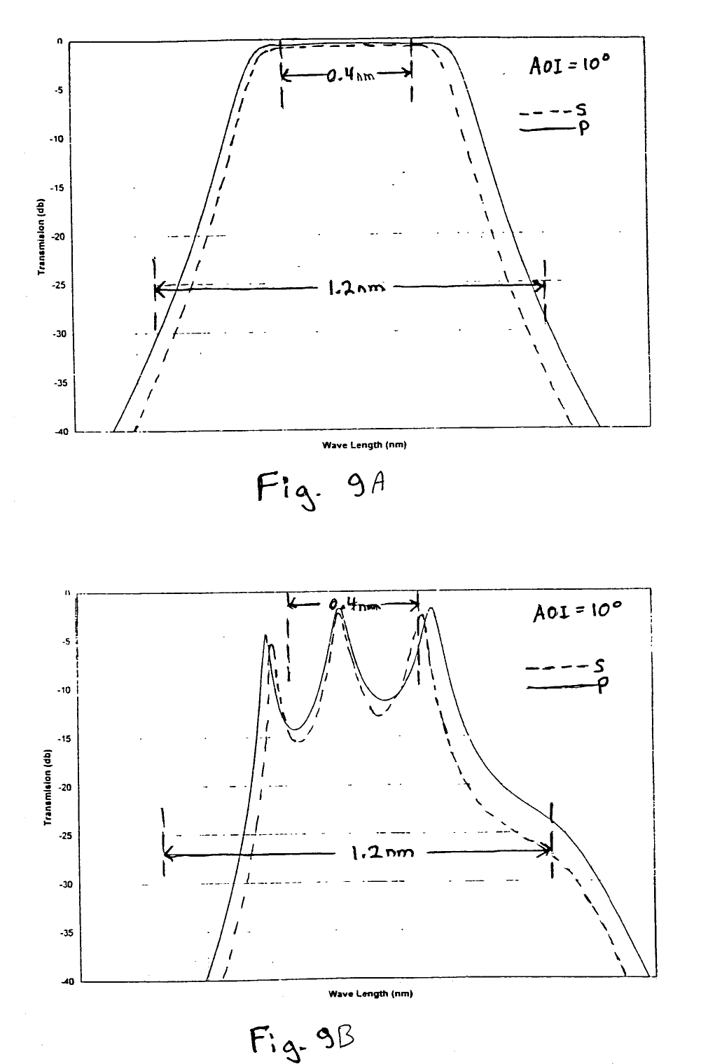

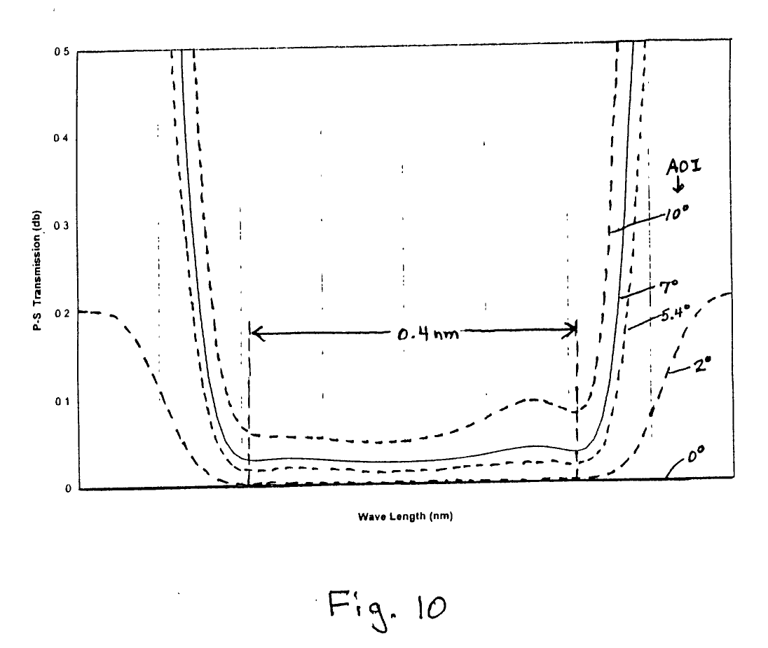

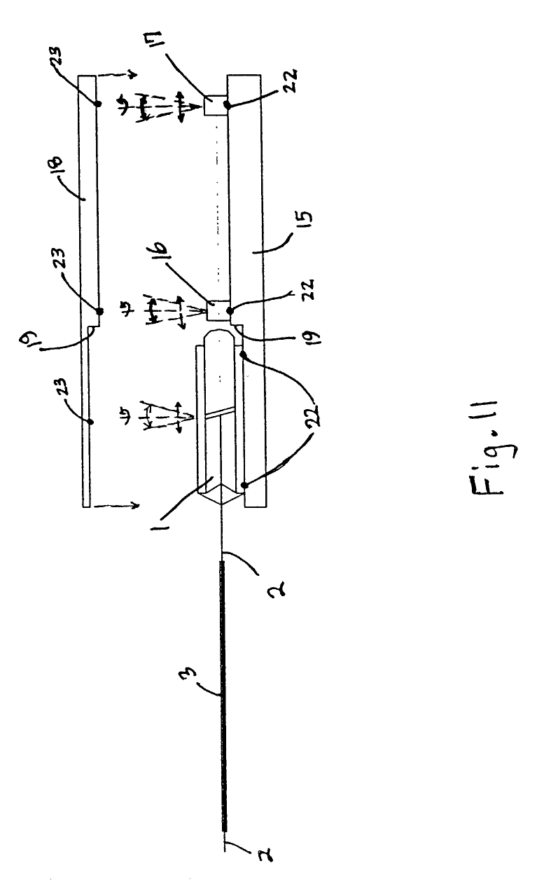

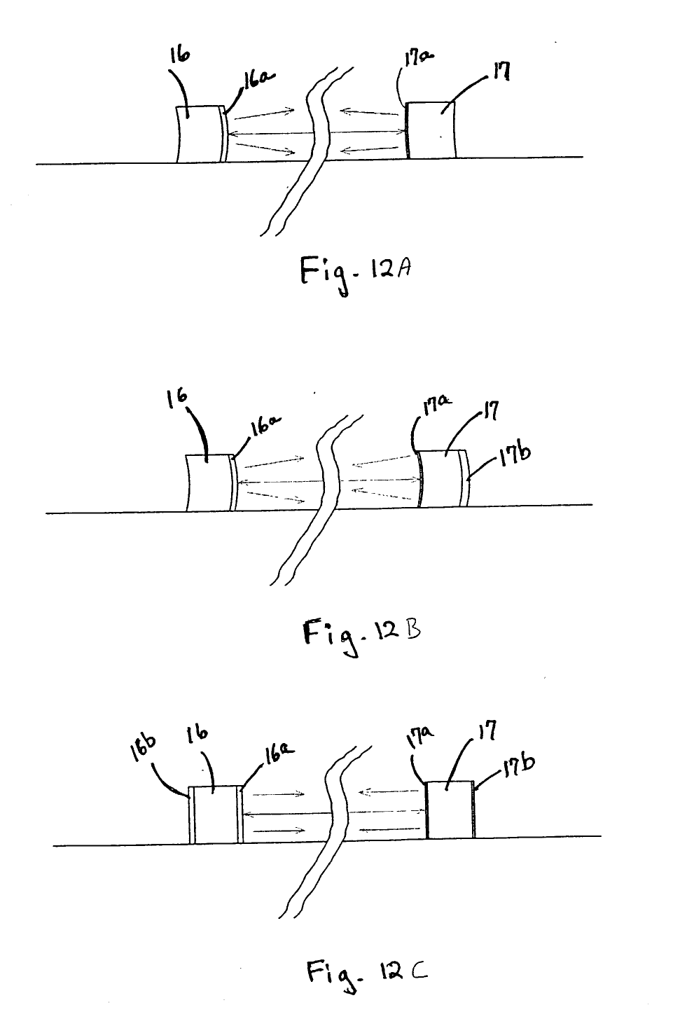

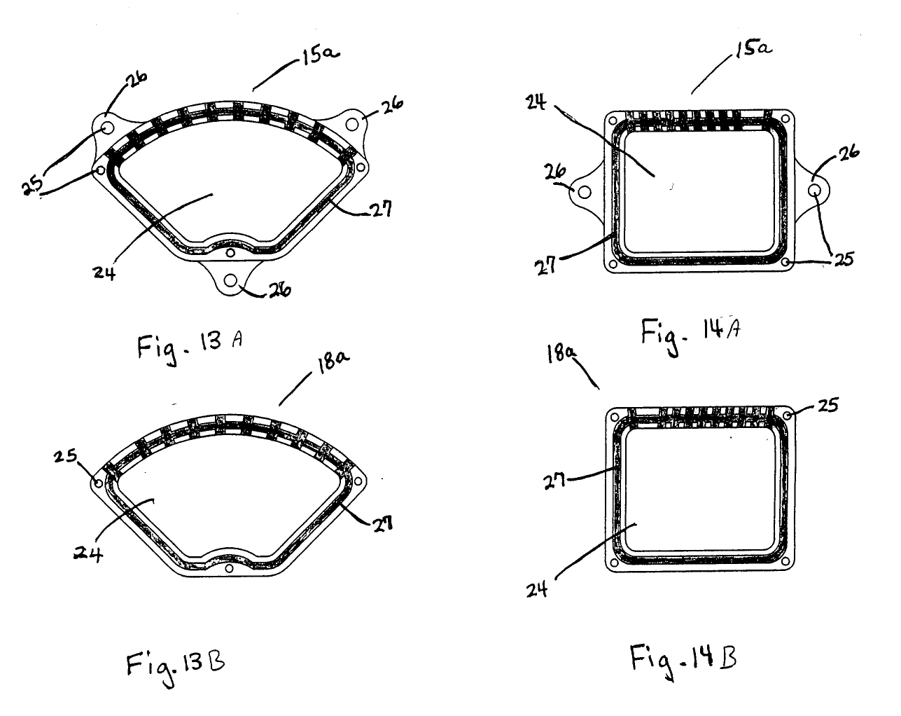

If the basic 8-channel linear device that is shown in FIG. 4A is laid out in the same way as that described for the extended channel device shown in 5b, the 8-channel device illustrated in FIG. 6A is the result. The angle θ is still 14 degrees as in the previous examples. Now the number of reflections is eight instead of sixteen, leading to a reduction in the variation of signal strength across the eight channels of less than 0.2 db. This small level of improvement in the variation of the signal strength of the channels is perhaps not enough to offset the disadvantages of having the ports on two sides, and the loss of a degree of freedom for aligning the components.

FIG. 6B shows the smallest practical device that could be made using the present architecture. It is an “add/drop” device used to mux (add) and de-mux (drop) a single channel. The angle θ of 14 degrees is preserved in this device as it was in the other linear devices. An input signal consisting of λₙ different input channels is fed into the device where a first filter 16 separates out one channel (λ₁ for example) and reflects all others to a second filter 16. Most commonly this second filter is identical to the first, i.e. it passes channel λ₁; although, it need not be identical so long as it is different for any of the other λₙ input signals. In the figure a laser source is used to add data on channel λ₁ back into the signal stream, so that λₙ signals emerge from the device. The net effect is that the original data on channel λ₁ has been dropped from the input signal stream, but new (different) data on channel λ₁ has been added to the output signal stream.

The preferred way to increase the channel count is to use a device of standard format (8 channels for example), and connect or cascade one device to a second and even a third or a forth device. This method has the advantage of a standardized basic platform for reduced manufacturing costs, while allowing later expansion when the need arises. FIGS. 7A, 7B, and 7C illustrate three ways that the channel count can be increased from eight to sixteen channels using the basic radial format as an example. Although not shown for convenience, the linear format can be expanded following exactly the same principals and procedures.

The first way the channel count can be increased is to connect the devices together serially. FIG. 7A shows two of the radial devices in FIG. 4A being connected together in this way. The last (pass-through) channel of the first device is used as the input to the second device to increase the de-muxed channel count to sixteen. The pass-through channel of the second device (λₙ₋₁₆) could in turn become the input to a third device, etc. Serial connection has the advantage of simplicity, but the signal for the last de-muxed channel has suffered reflection from all the other components ahead of it, while the first de-muxed channel has suffered only one reflection. This leads to the greatest difference between output signal strengths, or the greatest difference in insertion loss, across the band of de-muxed signals. To equalize the outputs, all the channel signal strengths must be reduced to the level of the last (lowest) one.

A second way of connecting the devices to increase channel count is shown in FIG. 7B. It uses a band splitting filter 20 in its first filter position. The other eight channel filters are each shifted one position so that the previous pass-through position now has an individual channel filter and becomes the last de-muxed channel. The band splitting filter has the property that it reflects the first eight channels to be de-muxed in the first device, and (ideally) transmits all of the rest. In reality it is very difficult to make such a wide filter with such a steep cut between channels, so a more practical filter is illustrated in the figure, i.e. passing only channels 12 through 40 as an example. Channels 9, 10, and 11 are “skipped” because of the filter shape. The signal output from the band splitting filter is used as the input to a second similar device, which has a band splitting filter for channels 23 through 40 in its first filter position. The sixteenth channel that is de-muxed (λ₁₉) now has less insertion loss than the sixteenth channel in the previous serial example because it has suffered only half of the reflection loss. The output signal (λ₂₃₋₄₀) from the band splitting filter of the second device could be input to a third, and that into a fourth device.

A third way of connecting the devices to increase the channel count is shown in FIG. 7C. This method utilizes a 2-port collimator 1a, like that described in FIG. 2A of the prior art. Filter 21 is a band isolating or “skip” filter. The technique is illustrated assuming an 8-skip-1 filter which passes eight channels but skips the one on each side of its band pass (0 and 9 in the first case). Ideally an 8-skip-0 would be preferred, but at present they are much more expensive and very difficult to produce. The eight channels passed by filter 21 are de-muxed in the next eight positions in the first device, and the remaining unskipped channels, 10 through 40, are reflected from filter 21 and collected at the second port of collimator 1b. These become the input to a second similar device, where a second 8-skip-1 filter 21 passes eight more channels (10 to 17) to be de-muxed. The reflected channels, 19 through 40 could be sent to a third similar device.

Adding filter 21 at the first collimator position, results in saving the cost of one collimator in the 8-channel device, since the last position that was used in the previous examples is now empty. As in the example shown in FIG. 7B, the last de-muxed channel has had fewer reflection losses, and therefore less insertion loss, than the serially connected devices of FIG. 7A. While the above examples used 8-channel devices for purposes of illustration, it is clear that the identical architecture could be accomplished using smaller 4-channel devices if the need arises. Devices of the present invention for DWDM use cannot be made arbitrarily smaller by increasing the AOI of the light path at the filters. The reasons for this will become clear from the following explanation. Consider first the transmission curves of the two 100 GHz 5-cavity filters illustrated at the same scale in FIGS. 8A and 8B. Both transmissions are calculated for an AOI of 0-degrees. The industry standard pass band of 0.4 nm and stop band of 1.2 nm at −25 db down from the transmission peak are marked in each figure. The filter in FIG. 8A is labeled Design A and that of FIG. 8B is Design B, and both represent different filter coating designs using quarter-wave mirror layers and half-wave cavity layers. For an AOI of 0-degrees (and small angles around 0 degrees), there is no essential difference in the S and P states of signal polarization, however the filter in FIG. 8B has the advantage of a sharper cutoff in the stop band, which better reduces interference from adjacent channels.

FIGS. 9A and 9B illustrate how markedly different the situation is when the AOI is increased to 10-degrees. Now the S (dashed) and P (solid) polarization components are significantly different from each other in both designs; however, the transmission shape of the filter in Design B has become totally unacceptable, while the filter in Design A still meets the standard specifications on pass band and stop band widths for each polarization component. The point here is not the differences in the filter designs. Any good computer optics code will predict that Design A type filters are superior when increasing the angles of incidence. The important point is that even the most optimum filter design has its limitations.

FIG. 10 shows the difference in transmission in db between the S and P polarization components as a function of wavelength for Design A type filters between 0 and 10-degrees AOI. This difference in transmission is called Polarization Dependent Loss (PDL), and the normal specification is that it must not be greater than 0.1 db in the pass band. FIG. 10 shows that this limit is essentially reached at an AOI of 10-degrees, and additionally, there is little manufacturing margin left for wavelength tolerance on the filter band pass center. The clear conclusion is that a mux/de-mux device for 100 GHz channel spacing (DWDM) cannot be made smaller by increasing the AOI beyond 10 degrees, and in fact 10 degrees allows little if any manufacturing margin. In the foregoing radial and linear designs the angles of incidence of 5.4 and 7 degrees are comfortably situated for the DWDM tolerances suggested in FIG. 10. For closer channel spacing, 50 GHz for example, the situation gets worse, meaning that the largest tolerable AOI is less than 10 degrees. For wider channel spacing (CWDM) the corresponding filters have pass bands that can be more than an order of magnitude wider than in DWDM. This allows CWDM devices to utilize filters with angles of incidence in the range of 13 to 14 degrees before the PDL becomes intolerable.

FIG. 11 is a schematic cross-sectional view representing either the radial or linear device. The cross section is taken along the light path from a mirror 17 to a filter 16 to a collimator 1. The components are labeled with numerical designations consistent with those used in preceding figures. Glass is the preferred material from which to fabricate the components since it is important to match their coefficients of thermal expansion. Materials other than glass are not excluded, for example, some types of stainless steel and invar have expansion coefficients close to glass. Bottom plate 15 functions as a miniature optical bench on which collimators 1, filters 16, and mirrors 17 are mounted. The sets of arrows above each of these components indicate that the robotic tooling has the freedom to translate the component slightly, tilt it back and forth, and rotate it about an axis to bring it into perfect optical alignment. A small translation of the component results in a small change in the AOI, which is within tolerances previously described. Because of this allowable tolerance in the AOI the filter can be slightly rotated to tune it to the exact channel wavelength, thus building in some tolerance in the filter manufacture. Black dots labeled 22 indicate the locations for the placement of small drops of adhesive for securing the components to the bottom plate. This adhesive should set solid and match the coefficient of thermal expansion of the glass components as closely as possible. It should be curable by UV or thermal energy or both. The adhesive should form a thin meniscus that supports the component without allowing direct glass-to-glass contact. Beginning with the first collimator each component is sequentially aligned and adhered in place. When all of the components are secured to base plate 15, top plate 18 is then attached to each component with a small drop of a different adhesive. Another set of black dots labeled 23 on top plate 18 indicate the location for the second adhesive, which does not set up solid but remains flexible. Securing the top plate in this fashion adds shock resistance to the part; however, it minimizes any thermally induced differential stress that could change the optical alignment of the components. As should be clear from the figures and description, there is no adhesive anywhere in the optical path.

One of the important factors influencing the insertion loss of each channel in the present device is the degree of accuracy in the collimation of the input signals. For the 8-channel device described here, the working distance of the first collimator should be about 200 mm to cover the total length of the optical path through the device. While collimators are readily available with stated working distances of this length, no lens surface is truly perfect, and there are minor variations from part to part. These lens aberrations can result in collimated beams that are either slightly converging or diverging with respect to perfect parallelism. This situation can be largely corrected by the introduction of a small amount of optical power (i.e. curvature) in the filters and mirrors.

FIG. 12A shows an enlarged cross-sectional schematic of the optical path between a typical filter 16 and a mirror 17 in the device. In this illustration the actual coatings on the glass blocks that create the filters and the mirrors are designated as 16a and 17a respectively. Filter 16 has an anti-reflection coating on the side opposite the filter coating, but it is too thin to materially affect the physical shape of the filter, so it is not explicitly shown. The stress generated in depositing both coatings 16a and 17a is intrinsically compressive. This stress is sufficiently high that the glass substrate is bent slightly convex on the coating side, the filter more so than the mirror. As indicated by the arrows in the figure, this small amount of negative optical power in the reflective filters and mirrors would cause an otherwise parallel beam to begin to diverge. Over the total length of the optical path, the collimated beam encounters this condition eight times for the filters and eight times for the mirrors in the 8-channel device described. In total this is an unacceptable amount of beam divergence. Of course if the input collimated beam were slightly converging, then the normally curved condition of the of the filters and mirrors in the device would tend to correct the convergence.

FIG. 12B illustrates the preferred way to make the curvature effects in the filters and mirrors cancel each other out so that no net optical convergence or divergence is added to the original collimated beam, which for this illustration is assumed to be perfectly parallel. The remedy is to add a coating 17b to the side of the mirror opposite to the reflective side 17a. Since light does not pass through the mirror, the additional coating does not have to have any specific optical properties, making it easier to produce. This coating compensates the curvature of the mirror to be equal and opposite that of the filter. The arrows indicate that the divergence added to the beam by reflection off of a filter is compensated exactly by the convergence added to the beam by its reflection off of a mirror. It is relatively straightforward with the sophistication of modern coating technology to achieve this cancellation with a very high degree of precision. In addition, if a small amount of net convergence or divergence is needed, it can be engineered in just by adjusting the thickness of coating 17b on the reverse side of the relatively inexpensive mirror. In this way variations in the performance of the collimators may be corrected as the device is assembled without adding significantly to the cost of the device.

A second way to cancel the effects of curvature in the filters and mirrors is illustrated in FIG. 12C. In concept this is the trivial solution, just put the same coating on one side of the component as on the other. While this is a simple solution for mirror 17 where coatings 17a and 17b are the same, it is rather complicated for the filter. Since the light signal for one channel must pass through the filter, coating 16b must not interfere with the transmitted signal. It could theoretically be identical to coating 16a, but the cost would be prohibitive. The practical solution here is for the coating to be a thick uniform layer of clear material that has a close index match to that of the substrate. Then one must add an anti-reflective coating that is designed to match the properties of the added layer. While simple in concept, this method is not as easy to implement in a manufacturing environment as that described in FIG. 12B, and it is much more expensive.

After the device is assembled and the optical alignment verified, it must be packaged in a protective container. A primary objective of the container is to keep moisture from getting into the device. Should this occur, a falling temperature would cause condensation on the optical surfaces, resulting in an unacceptable loss of optical signal. In addition, the container should provide a buffer to help protect the device from both mechanical and thermal shock. In the current state of the art most of the modules shown in FIG. 2A are hermetically sealed around each collimator with a solder joint. Solder sealing of the glass fiber itself is possible by first metallizing the fiber in the sealing area. While effective, this method is expensive, and it requires that some regions of the device withstand unusually high temperatures during the sealing process, which can result in misalignment of a previously well aligned device. The container in which a number of these modules are packaged to make a mux/de-mux device is usually O-ring sealed. The packaging method of the present invention is very effective, and it does not require elevated soldering temperatures or metallization of the glass fibers. The present invention borrows from techniques and materials that have been tested and proven in the insulated window glass industry.

An insulated glass unit (IGU) consists of two or more panes of glass separated by an extruded aluminum spacer that is slightly smaller than the size of the glass pane. In one sealing system a bead of isobutylene (butyl) is applied to each side of the spacer. Then the panes of glass are pressed against the spacer from either side. The butyl adheres well to both the aluminum spacer and the glass panes forming a waterproof seal that never fully hardens. The IGU is then held together mechanically with a polysulfide or polyurethane adhesive that fills a remaining gap all around the perimeter of the unit. A second kind of sealing system utilizes a thermally reactive type of butyl, which performs both the sealing and the mechanical joining functions in one application. Both types of seals remain intact through years of winter/summer and direct sun heating cycles and high humidity, similar to the conditions that must be endured by the mux/de-mux device.

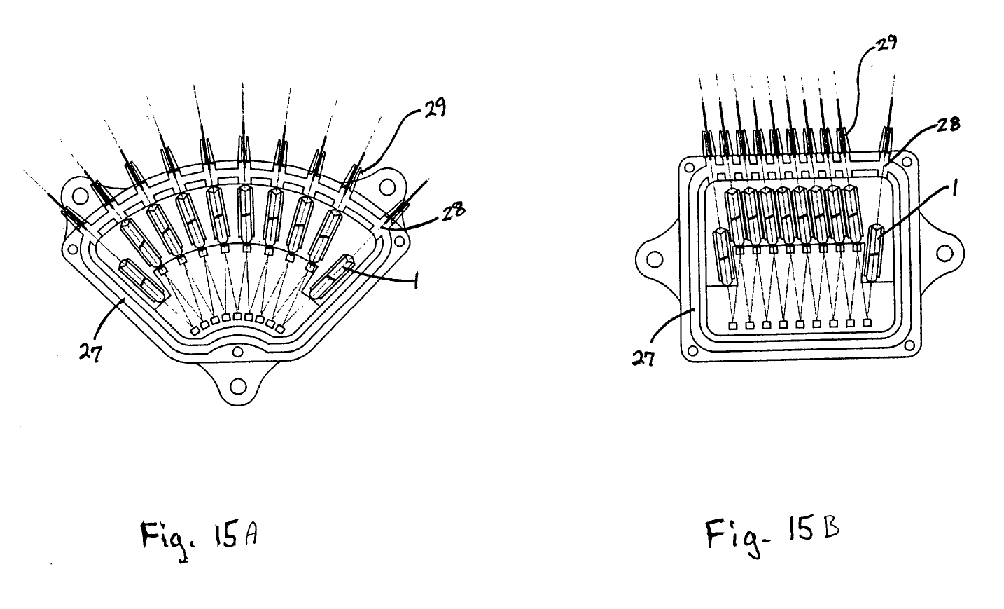

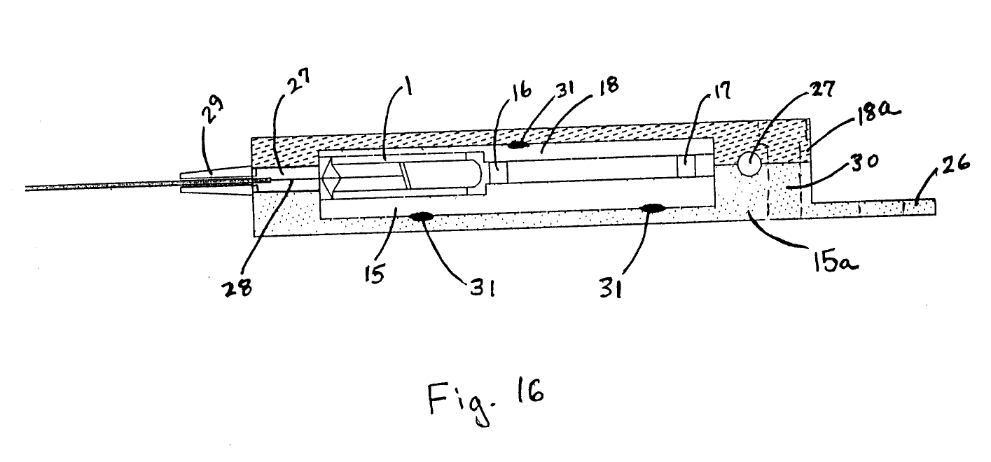

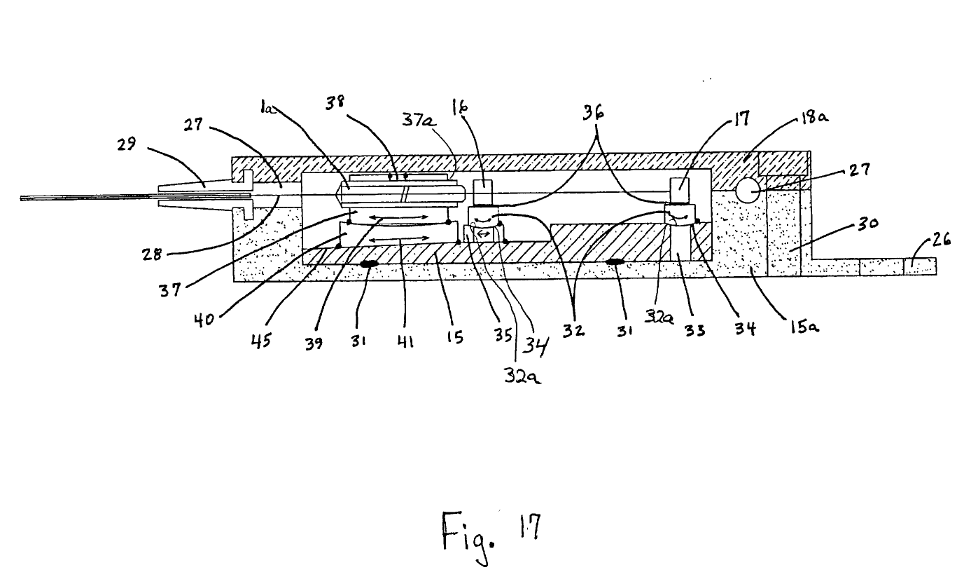

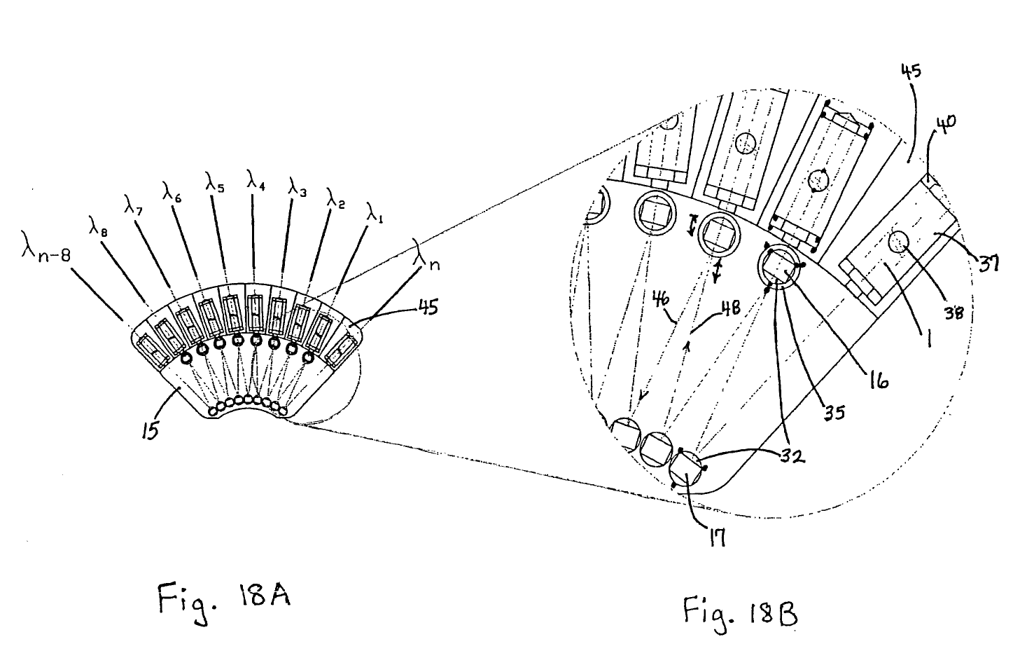

The container for the radial device is shown in FIGS. 13A and 13B, and the container for the linear device is shown in FIGS. 14A and 14b. The preferred construction material is aluminum because of the forgoing discussion of sealing IGU's; however, several other metals or other materials, especially stainless steel, could be used. It is anticipated that manufacturing of the container in volume can be done by a metal casting process to substantially reduce machining costs. Each container is a symmetrical clamshell like structure consisting of bottom (15a) and top (18a) halves, the bottom half being somewhat thicker than the top half in proportion to the difference in thickness of the bottom and top plates of the device as previously described. The plan views are from the inside of the containers. The opposite sides (outside) are flat and featureless except for screw holes 25. Each half of the container has a recessed cavity 24 whose shape matches that of the device, but with enough clearance to prevent actual contact between the device (glass) and the container (aluminum). The bottom halves have thin protruding tabs 26 with holes for mounting the device to a circuit board or other network platform. Each half has a recessed channel 27 (shaded) in which the butyl seal is formed. While butyl or a form of butyl is the preferred sealant, other adhesives could be compatible with the design. Several epoxies and metal powder filled epoxies could probably be formulated to match the thermal expansion of the materials closely enough to seal without inducing excessive stress during temperature changes.

FIGS. 15A and 15B are top plan views of the radial and linear formats of the device, as they would appear when the devices (without top glass covers) are placed into the bottom half of their respective containers. FIG. 15A is a superposition of FIG. 4A onto FIG. 13A, and FIG. 15B is a superposition of FIG. 4B onto FIG. 14A. The bottom surfaces of base plates 15 of FIGS. 3A and 3B do not physically touch the recessed surfaces of cavities 24 of FIGS. 13A and 14A, rather they are thermally insulated from direct contact with the metal surface by a similar flexible adhesive to that described above in FIG. 11 for mounting top glass plate 18 to the tops of the optical components. A three point adhesive mount is acceptable for either format. The sealing of the unit around the glass fibers is the most challenging aspect of closing the container. In the present invention the fibers that emerge from collimators 1 are stripped to the glass cladding surface 28 so that the butyl in channel 27 will flow around and seal to the glass over a few millimeters of its length. Neither high temperatures nor metallization of the glass fiber is required. Stress relief boots 29 are placed around each fiber and retained at the edge of the device by an adhesive or a small slot that would be cast into the edge of the part.

FIG. 16 is a scaled schematic cross-sectional view of the assembled radial device. Elements in the figure carry numerical designations that are consistent with those used in previous figures. Except for the location of mounting tab 26, the figure is relatively correct for the cross-sectional view of the linear device as well. The basic device consists of base plate 15 and top plate 18 with the optical components mounted in between. The bottom half, 15a, and the top half, 18a, of the symmetrical clamshell container are held together by screws 30, while butyl seal 27 provides the moisture barrier between the metal surfaces and around glass fiber 28. The basic device does not physically touch the clamshell container in order to avoid a conductive heat transfer path that would create the potential for thermal shock. The device is mounted to the bottom half of the container by a thermally insulating flexible adhesive applied in spots indicated by black ovals 31. At least one such spot is included between the top half of the container and top plate 18 to improve the shock resistance of the device.

FIGS. 17, 18A and 18B illustrate an alternate mounting technique for the collimators, mirrors and filters. Because the long term (on the order of 20 years) stability of currently available UV and thermally cured adhesives is largely unknown, an alternative embodiment, which both limits their use and minimizes the effects of any changes with time and temperature, is desirable. The proposed alternative embodiment utilizes additional mounting components, and is especially ideal for the radial device. For the linear device, the larger mounting area required for the additional mounting components may result in either an increase in the AOI at the filters, or an increase in the optical path length and overall size. Therefore, for some applications of the linear device, especially DWDM applications, the added mounting components may not be ideal.

For the radial device, the additional mounting components require only that the overall thickness be increased slightly, which is an acceptable compromise. The growing availability of high quality miniaturized collimators allows the construction of mounting components that do not require an enlargement of the radial footprint. This alternate mounting embodiment makes maximum use of laser welding of the components to minimize both long-term thermal problems and assembly time. Laser welds require only seconds to reach stability while UV curing of adhesives requires a minimum of several minutes. Although the assembly method described in FIGS. 11 and 16 has lower material costs and fewer components, it suffers from a higher risk of possible long-term thermal instability, extended assembly times for adhesive curing, and post cure shift. This alternate mounting embodiment is somewhat more costly, but more robust, and the assembly times are shorter.

A cross-sectional schematic view of this alternative mounting embodiment is shown in FIG. 17. Elements common to those of previous figures are labeled with the same numerals. There are two design approaches to maintaining thermal stability. One approach is to make as many components as possible from materials that have very low thermal expansion to minimize all thermally induced movement. The other approach is to match the thermal expansion of as many components as possible so the components move together. In accordance with the first approach base plate 15 is constructed of Invar, an alloy of iron and nickel that has extremely low thermal expansion. It is secured to and thermally isolated from bottom cover 15a by adhesive 31 as previously described. Mirrors 17 and filters 16 are mounted on cylindrical Invar pedestals 32, which have top surfaces that are flat and bottom surfaces 32a that are curved (convex). Holes 33 are drilled into base plate 15 and a curved (concave) annular region 34 is formed at the edge of each hole to match the curvature of the convex surface 32a of the pedestal, thereby creating small ball joints when the pedestals 32 are mounted over holes 33. Each of the pedestals 32 under the filters 16 is seated upon a ring shaped support structure 35 also made of Invar. The base of the ring shaped support structure 35 is flat while its top has the same curved (concave) annular region 34 (with a hole in the middle) to form the same ball joint geometry as that of the pedestals 32 under mirrors 17. The ball joint geometries allow pedestals 32 (and filters/mirrors 16/17 mounted thereon) to be rotated and then affixed for proper alignment.

Filters 16 and mirrors 17 are secured to pedestals 32 by a very thin uniform layer 36 of epoxy or solder. Solder has the advantage of strength, but the mirror and filter bonding surfaces have to be metalized in a vacuum system prior to the soldering operation. Expansion coefficients can be similar for either material. It is important for the bond layer to be uniform in thickness to avoid differential tilting of the filter or mirror during changes in temperature. The joining of the mirrors and filters to their pedestals is preferably done as a preliminary operation before the actual robotic assembly of the device. The curved arrows on the pedestals indicate that during assembly the filters 16, mirrors 17 and respective pedestals 32 can be tilted in any direction for proper beam alignment. In addition, these elements can be rotated about their vertical axes as well. The use of the ring shaped support structure 35 for mounting the filters provides each filter with an additional (lateral) degree of freedom (as indicated by the arrow) for adjustment on base plate 15. This allows the band pass of each filter 16 to be precisely tuned to the specified channel frequency, thus easing the tolerance of the center wavelength placed on filter manufacturing. Cheaper filters can be used without sacrificing device performance—an important economical benefit. When it is determined (e.g. by a robotic device) that the mirrors 17 and filters 16 are in the correct positions, they are secured in place by laser spot welds that fix the ring support structures 35 to the base plate 15, and fix the pedestals 32 to the ring support structures 35 or to the base plate 15. The laser pattern is preferably symmetrical around these parts so that any potential movement from weld shrinkage is minimized. In the figure the approximate locations of the spot welds at element interfaces are schematically indicated by black dots, but the actual pattern is not properly rendered in this cross-sectional view.

Collimators 1 and 1a are each mounted inside a close fitting hole 37a formed through a rectangular mounting block 37 of Invar. A small Invar pin 38 is pressed against each collimator and spot-welded to hold the collimator in place. Alternatively the collimator could be held inside mounting block 37 with an adhesive as long as the bond layer were uniform all around to cancel any thermal expansion effects. Mounting of the collimator into mounting block 37 is preferably done as a preliminary operation because the output beam of the collimator is not guaranteed to be concentric with its physical housing. A typical specification for beam divergence is 0.25 degrees. Since the total path length of the folded beam is about 8 inches in this device, a rotation of the input collimator 1 results in the beam spot tracing out a circle 0.035 inches in diameter at that distance. The mirrors 17 and filters 16 for the preferred embodiment are only 0.055 inches square, so the uncertainty in beam direction is too large. This uncertainty is minimized in the pre-assembly operation by rotating the collimator to one of the two positions where the beam is in the horizontal plane of the axis of the collimator housing before securing it in place. By going through this preliminary alignment step, the degree of tilting (arrow 39) of the collimator to align the beam during device assembly is greatly reduced.

Mounting block 37 is supported on an Invar skid or mounting plate 40 whose upper surface is curved (concave) in one dimension. The leading and trailing edges of mounting block 37 are curved to match the curvature of the skid plate, thus forming a one-dimensional ball joint. The bottom surface of skid plate 40 is sloped at an angle of approximately 2 to 5 degrees. The region of base plate 15 on which the skid plate can slide is indicated as region 45 (actually a facet) and it has a slope that matches that of skid plate 40. Arrow 41 shows the allowed movement direction along the slope. Alignment is accomplished by sliding mounting block 37 and skid plate 40 together towards or away from filter 16 to change the height of the collimator without changing its tilt. Tilt is independently adjusted by moving mounting block 37 with respect to skid plate 40 as indicated by arrow 39. Finally, the horizontal alignment is corrected by rotating skid plate 40 and mounting block 37 slightly (no more than 0.25 degrees) about a vertical axis. When proper alignment is achieved, two sets of simultaneous laser spot welds (between mounting block 37 and skid plate 40, and between skid plate 40 and base plate 15) secure the components in place. Because the collimator, mirrors, and filters are all about the same size, the total thickness of Invar beneath each component is approximately the same.

The Invar approach just described attempts to keep optical alignment thermally stable during temperature changes, but as previously mentioned, another approach is to match the expansion coefficient of the components. It turns out that this method is practical for this alternative embodiment just by changing the Invar to another metal. Stainless steel is a good choice because weldable alloys exist that have a good match to the expansion coefficient of the type of glass that must be used in the filters to make them insensitive to band pass shift with temperature changes. In addition, UV/thermal curable epoxies are now available that have expansion coefficients near that of the glass and stainless steel. This approach solves what might be a potential problem with the adhesive joint between the mirrors and filters and their pedestals. Since the Invar has a very low expansion coefficient, and the glass has a much higher expansion coefficient, changes in temperature could induce a rather large stress in the adhesive joints therebetween, leading to a mechanical failure of the joint. This potential problem is overcome by making the components out of stainless steel instead of Invar.

The container for this embodiment consists of a symmetrical clamshell like structure with bottom (15a) and top (18a) halves as explained above. A boot 29 is included to support each of the optical fibers terminating at the device. Boot 29 is retained by small semicircular slots in the top and bottom halves of the clamshell structure for stress relief. This embodiment does include a top plate 18 as was shown in FIG. 16. The higher strength of the welded structure adds robustness against mechanical shock and vibration, and therefore top plate 18 is not needed for most applications.

FIG. 18A shows a plan view of the device with the additional mounting components. With the smaller diameter collimators (1.6 mm) the components still fit into the same radial format as the previous layout shown in FIG. 4A. The embodiment of FIG. 18A includes regions 45 that are ten facets on the outer surface of the base plate 15, all with the same slope with respect to the flat region on which the filters and mirrors are mounted. Additionally, the first and last collimators are shown placed along the same radial arc as the central eight collimators, to simplify the robotic programming and to reduce the number of operations and shorten assembly time. Detailed optical modeling studies show that the insertion loss is only slightly sensitive to the total distance between the collimators, so little is lost by this change in the positions of these two collimators. The most sensitive error is tilt, which this alternative embodiment with laser welding does a good job of addressing.

FIG. 18B is an expanded view of a circular section of FIG. 18A to show the individual mounting components is greater detail. At a minimum two symmetrically placed welds are required to minimize the effects of weld shrinkage and thermal expansion. For circular components a better kinematics design is three equally spaced welds. Black dots indicate welding spots for one of several possible ways this welding pattern can be implemented for pedestals 32 and ring support structures 35. For rectangular components 37 and 40, spot welds near each of the four corners is the most stable pattern. Some variation in the welding patterns could be made in order to avoid obstructions from robotic manipulators or other structures without significantly impacting the effectiveness of the welds.

FIG. 18B also illustrates the way the filters can be tuned to adjust their band pass centers to fall at the specified channels. For 100 GHz DWDM channel spacing, the channel centers are approximately 0.8 nm apart. Therefore, the most any particular filter can be off of a channel is 0.4 nm. For this amount of band pass shift, the filter only has to be turned by 0.4 degrees (0.2 degrees for 50 GHz channel spacing). Up to this maximum amount of angular tuning, the AOI at the filter could fall anywhere between 5 degrees and 5.8 degrees (5.4 degrees nominal +/−0.4 degrees). Evaluation of this amount of angular variance with respect to FIG. 10 reveals that the corresponding variation in polarization dispersion loss is extremely small and functionally acceptable for the device.

The two-headed curved arrow of FIG. 18B indicates the rotation of the filter 16 on its vertical axis (perpendicular to the view) by a maximum amount of +/−0.4 degrees. This excursion causes the intersection of ray 46 with the next mirror 17 to move along the mirror's surface by only +/−0.0035 inches, which is far too small an increment to show in the figure. To restore ray 46 to its original location on the mirror, the filter must be moved along ray 48 (without rotation) by at most +/−0.010 inches. The straight two-headed arrow of FIG. 18B indicates this motion. The collimator position must then be slightly adjusted from its nominal position to reacquire the maximum signal. Since this adjustment causes a small but acceptable change in the angle of the light beam at both the mirror and the filter, it cannot be continually used in the same sense for successive channels. However, it is relatively easy to select the filters so that the correction alternates in direction for one channel to the next. This innovative aspect of the design has a large positive impact on the cost of filters, since all the filters on a coating run that have acceptable shape can be used in the device, not just those whose center band pass wavelengths lie within the tolerance of standard channel positions.

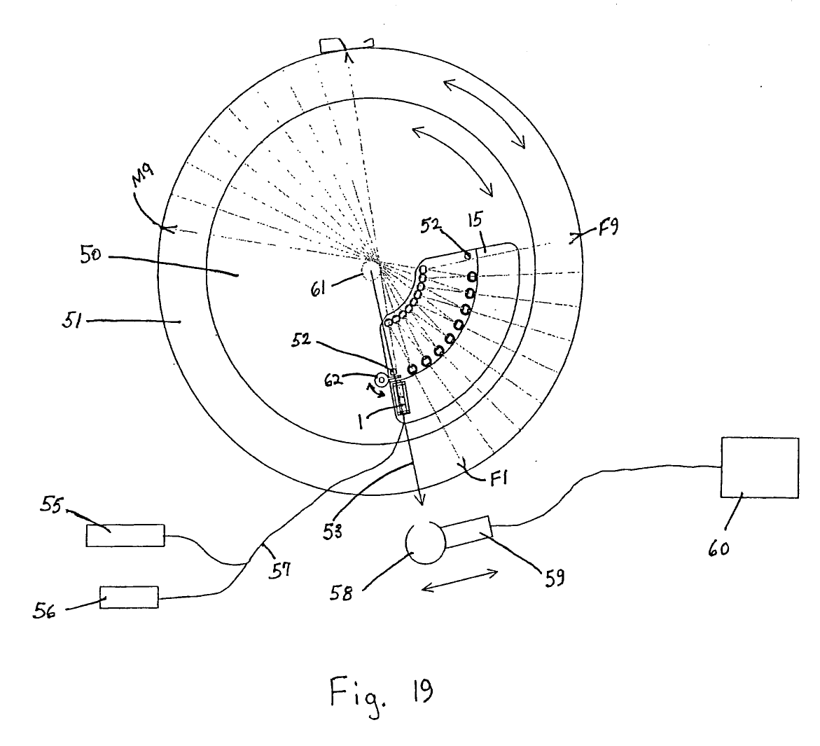

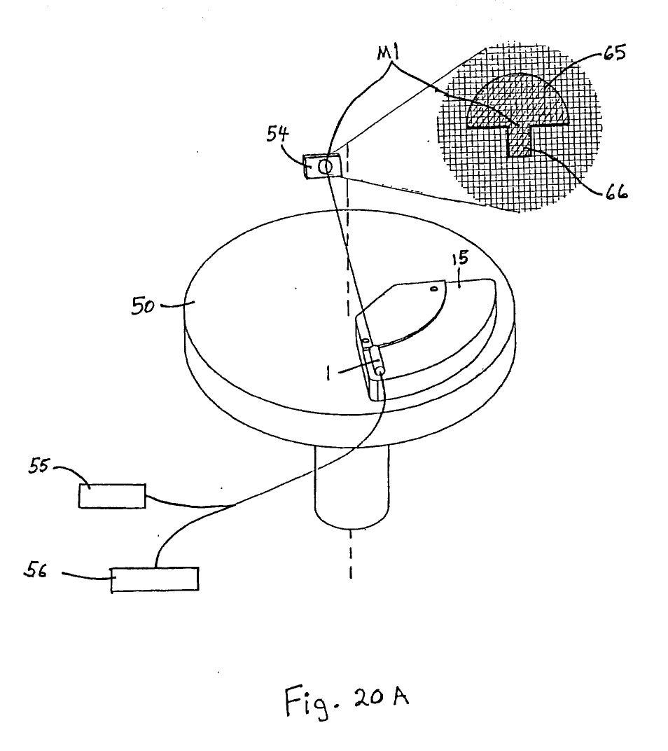

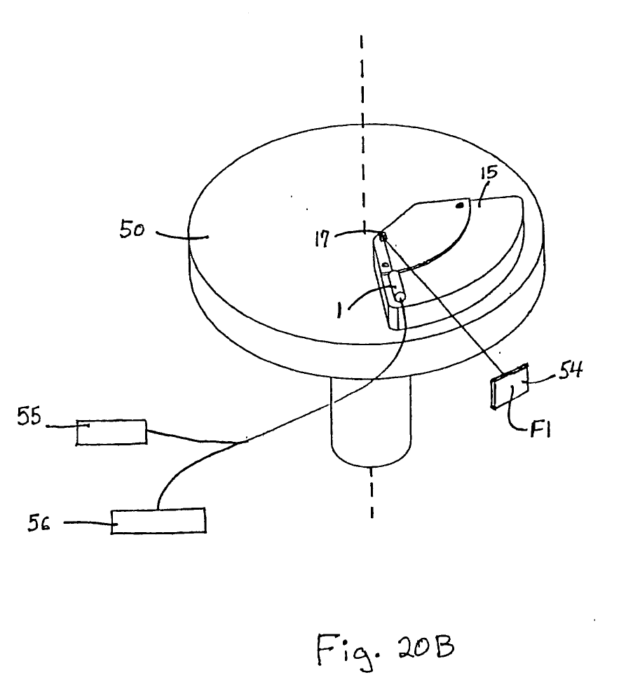

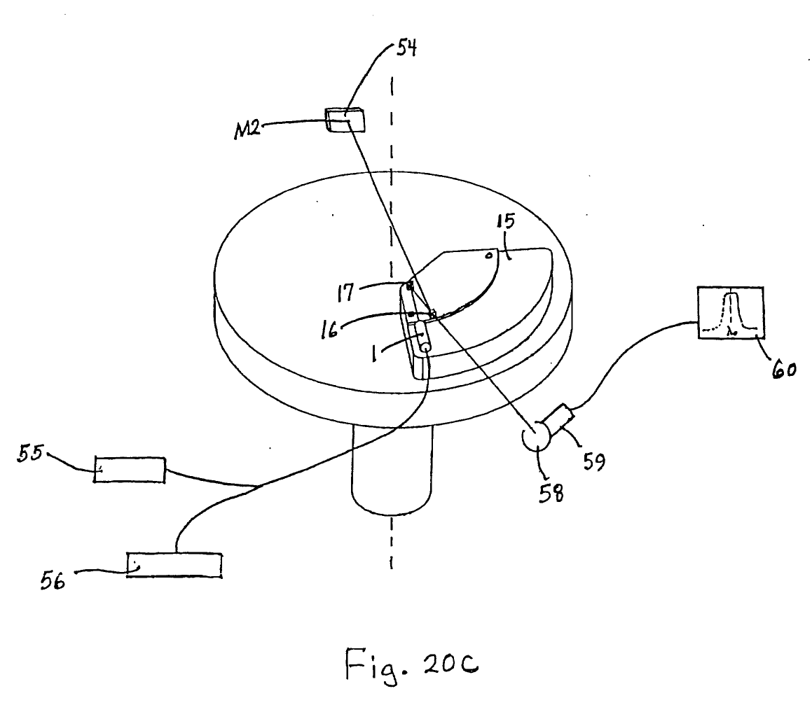

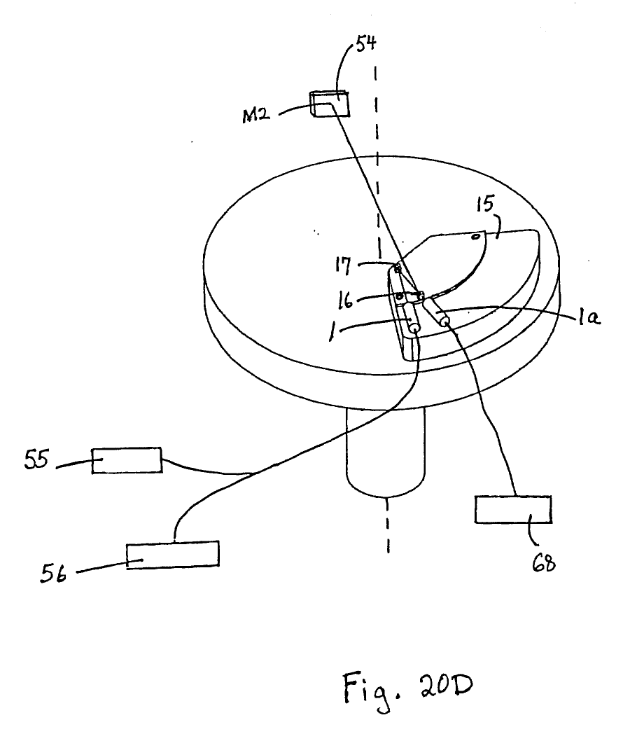

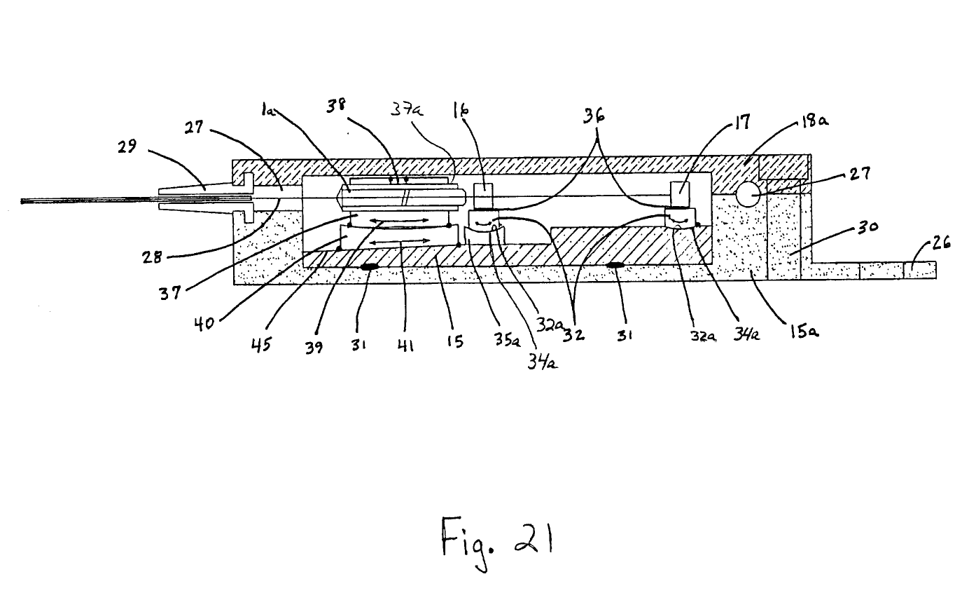

FIGS. 19 to 20D illustrate a robotic method and apparatus for assembling the radial embodiments of the present invention described above, whether or not the additional mounting components of FIG. 17 are used. FIG. 19 is a schematic plan view of a preferred system layout for robotically assembling the radial device. The layout consists of two round co-rotating servo tables 50 and 51. Device base plate 15 is mounted to table 50 by, for example, locating pins 52, but blocks with clamps or other devices could also be used so long as each base plate 15 goes to the same reference position on the table each time it is mounted. Arrow 53 indicates the major reference axis (line) for robotic manipulation of the components. The direction is arbitrary. In FIG. 19, table 50 is rotated so that the first collimator 1 is approximately in position for alignment. In successive operations, table 50 rotates the next component position to lie along line 53 before robotic alignment of that component. Table 51 is equipped with a detector 54 (e.g. a CCD array) that is used to image the laser beam generated by lasers 55/56. Detector 54 need not be large or expensive for this operation. An array of 512×512 pixel elements is adequate. Typical pixel sizes are 6 to 10 microns, making the active surface of the array about a quarter inch square. Typical readout times are faster than a millisecond. Two lasers are supplied. Laser 55 is a tunable telecommunications laser whose standard output wavelength range is typically the S, C, or L band (about 1.5 microns). Laser 56 is a much less expensive Helium-Neon (HeNe) or diode laser that has a green light (532 nm) output appropriate to a reflection band in the visible light region for the filters and mirrors used in the telecom bands. The output from each laser is combined into a single fiber optic cable 57 for input to the system (e.g. via the collimator 1). The green laser light is detected by the CCD array, and a human operator can see the beam to aid in initial alignment. An integrating sphere 58 and wavelength photodiode detector 59 are preferably positioned in a fixed position relative to the rotating tables. The output of the detector 59 is displayed or stored on device 60, which could be a computer and/or computer monitor, and indicates the center wavelength of light incident thereon.

The base plate 15 has nominally known positions for all of the collimators, mirrors and filters. The path of a laser beam exiting the first collimator 1 can be projected along a nominal zigzag path between the positions for mirrors 17 and filters 16, as shown in FIG. 19. The laser beam can also be projected past the mirror and filter positions, where it forms opposing but similar fans of beams propagating in opposite directions. With the base plate 15 secured to the table 51 in a known position, the beams passing through the mirror positions are tangent (each at a different place) to a small circle 61, whose center is also the center of the arcs defining base plate 15. These beams intersect the outer edge of servo table 51 at known target positions M1 through M9. Similarly, the beams that pass through the filter positions intersect the outer edge of servo table 51 at known target positions F1 through F9. These beam patterns and target positions are determined and retained for the base plate 15 and servo table 50, however, through computerized coordinate transformations servo table 51 always knows the locations of the beams no matter what the position of servo table 50 happens to be.

The four most basic steps in the robotic assembly of the device include the alignment of the input collimator 1, the alignment of the mirrors, the alignment of the filters, and the alignment of the output collimators. These basic steps are shown in FIGS. 20A through 20D. Each illustration is an isometric sketch derived from the basic layout shown in FIG. 19. Only essential components are explicitly shown in these figures. All elements are labeled with numerals consistent with elements in previous figures.

FIG. 20A shows the alignment of the input collimator 1. With the first collimator 1 placed on the base plate 15, the servo plate 50 is rotated so that collimator 1 is disposed along reference axis 53, and the servo plate 51 is rotated so that CCD array 54 is disposed at target position M1. The collimator 1 is manipulated (preferably robotically) to move the beam from the green laser exiting collimator 1 to the center of the CCD array 54. The robotic system receives a feedback servo loop signal from the array output while it manipulates collimator 1.

To insure that the beam is also parallel to the surface of the base plate 15, a small rotatable flag or arm 62 is permanently referenced to table 50 and is used to set the height of the beam as it exits collimator 1 (see FIG. 19). The flag has a narrow reference slot having a width that is less than the diameter of the laser beam (e.g. about 0.5 mm), which is used as a reference for the angular alignment of the first collimator. The point of intersection of the slot with the top edge of the flag and the center of the CCD array define a line which is parallel to the surface of table 50 and at the proper input angle with respect to base plate 15. As shown in the pixel-level enlargement of the array in FIG. 20A, the laser beam 65 has its bottom half (shown as element 66) occulted by the flag 62. The length of the notch in flag 62 is not important, so long as it can be clearly distinguished to allow centering of the pattern at the pixel corresponding to target position M1 (see FIG. 19). The centering is preferably performed by using a computer algorithm that uses all the intensity information from all of the illuminated pixels to obtain accuracy on a scale much smaller than the size of a single pixel. The edges of the images will not be as sharp as indicated in the drawing due to diffraction effects, but this will not introduce a significant positioning error because of the averaging effect from all of the pixels. When the collimator 1 is properly aligned, it is secured in place (e.g. by an adhesive or laser spot-welds).

FIG. 20B illustrates the alignment of the first (or any) mirror 17. CCD array 54 is rotated around to sit at target position F1 as described earlier. The mirror 17 is placed at its nominal position and manipulated to align the beam reflected therefrom at the center of the CCD array at target position F1, which positions the reflected beam at the center of the next filter position. The flag in front of the input collimator 1 is preferably rotated out of the beam so that the full circular spot of the beam is centered at target position F1 by manipulating mirror 17. After the mirror is accurately aligned, it is secured in place (e.g. by an adhesive or laser spot-welds). If the mechanical tolerances of the components are held reasonably tight, the laser beam will be centered on the mirror face within about 0.001 inches.

FIG. 20C shows the alignment of the first (or any) filter (16). CCD array 54 is positioned at the next mirror target position M2. The filter is placed at is nominal position and manipulated to align the beam reflected therefrom at the center of the CCD array at target position M2, which positions the reflected beam at the center of the next mirror position. Integrating sphere 58 with detector 59 is positioned to receive the beam transmitted by the filter. Since the integrating sphere has a relatively large entrance aperture, nominal positioning at each predetermined point is adequate to insure the beam enters the opening. Telecommunication laser 55 is scanned in wavelength, and the light passed by the filter is sensed by detector 59 and passed to device 60, where the center wavelength of the pass band is determined and/or displayed. If the filter is not perfectly centered on the desired channel, the computer generates an error signal, which causes the system to rotate the filter to correct the band pass center as discussed with respect to FIG. 18B. This rotation misaligns the reflected beam, so the filter is then translated towards or away from the previously placed mirror 17 until the beam reflected by the filter is centered again at target position M2 (as measured by detector 54). After these adjustments, the filter is secured to the base plate (e.g. by an adhesive or laser spot-welds).

FIG. 20D illustrates the alignment of one (any) of the channel collimators 1a. Each collimator is positioned on the base plate in its nominal position, with a power meter 68 set up to monitor any optical signal output therefrom. Since the filter band pass has been aligned to the correct channel position, it is only necessary that scanning laser 55 be set to that wavelength, where the collimator 1a is manipulated until the signal strength sensed by power meter 68 is maximized. The collimator 1a is then secured in position (e.g. by an adhesive or laser spot-welds).

The steps described above with respect to FIGS. 20B, 20C and 20D are repeated to position and align the remaining mirrors 17, filters 16 and collimators 1a. It should be noted that the four steps that have just been described need not be done in the order that was used in the illustration. For example, after the input collimator is installed, it is acceptable to mount all of the mirrors and filters first, and then go back and mount all of the collimators one after the other. If two robotic assembly tools are available, the filters and mirrors could be mounted on one tool, and then the part moved to the second tool for collimator mounting. How the sequencing is done will depend on the demands made on production volumes and how best those demands can be met with minimum costs.

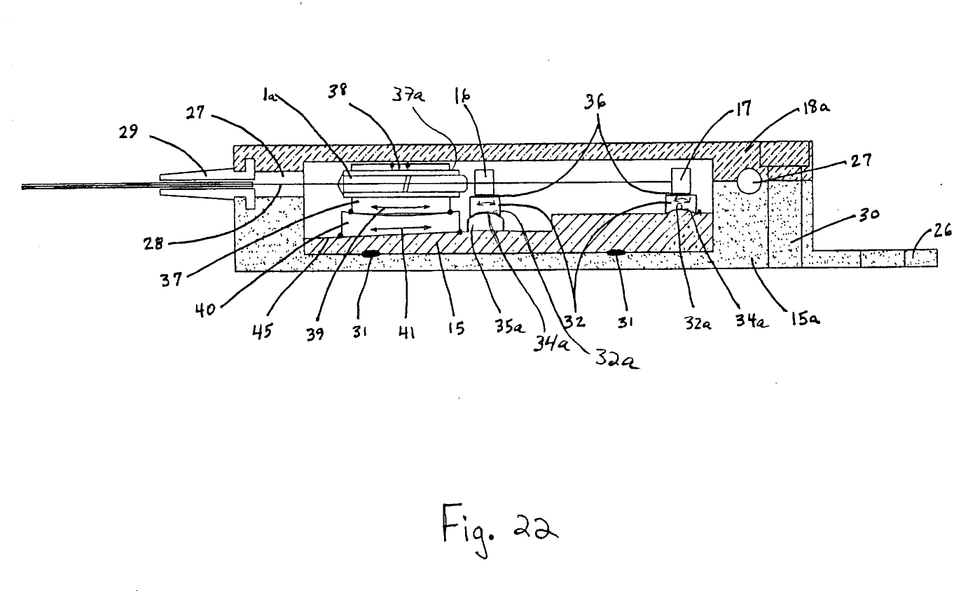

It is to be understood that the present invention is not limited to the embodiments described above and illustrated herein, but encompasses any and all variations falling within the scope of the appended claims. For example, the ring support structure 35 used to support the filter pedestals could also be used to support the mirror pedestals instead of holes 35. Further, mounting block 37 could be omitted, where collimators 1a are mounted directly to the skid plates 40. Moreover, ring support structure 35 (and curved annular region 34 thereon) could be replaced by a solid support structure 35a having a solid curved (concave) upper surface 34a, and/or hole 33 (and curved annular region 34 thereon) can be replaced with a solid curved (concave) surface 34a formed in the base plate 15, as shown in FIG. 22. The curved annular region 34 of hole 33 and ring support structure 35 (having an open center) are easy to fabricate so that they provide a good ball joint with the curved (concave) bottom surface 32a of pedestals 32, but solid curved (concave) surfaces 34a as shown in FIG. 21 will suffice as well. Likewise, the direction of curvature for concave and convex surfaces can be swapped (e.g. curved surface 32a can be concave and curved surface 34 can be convex as shown in FIG. 22) and still provide the ball joint geometry of the present invention. It should be appreciated that although the above description refers to optical devices that produce a plurality of channel wavelengths which the present invention multiplexes and de-multiplexes, each of the channel wavelengths in fact includes a finite range of wavelengths, even channel wavelengths produced by narrow band optical sources.

What is claimed is:

1. An optical wavelength multiplexer and de-multiplexer device, comprising
a base plate having a surface;
a first optical collimator for receiving multiwavelength light and producing a substantially collimated free-space beam of the light over the base plate surface;
a plurality of support structures mounted to the base plate;
a plurality of first pedestals each having a curved bottom surface mounted to one of the support structures;
a plurality of optical filters each mounted to one of the first pedestals for receiving the light beam, for transmitting any portion of the received light beam within a predetermined wavelength range, and for reflecting the untransmitted portion of the received light beam to another of the optical filters;
a plurality of mounting plates mounted to the base plate surface and each having a curved top surface;
a plurality of optical collimators each for focusing one of the transmitted portions of the light beam from one of the optical filters into one of a plurality of output optical fibers, wherein each of the optical collimators is mounted over one of the mounting plate top surfaces.

2. The optical device of claim 1, further comprising:
a plurality of mounting blocks each having a bottom surface that is mounted to one of the mounting plate top surfaces, wherein each of the optical collimators is mounted to one of the mounting blocks.

3. The optical device of claim 2, further comprising:
a first mounting plate mounted to the base plate surface and having a curved top surface; and
a first mounting block having a bottom surface that is mounted to the first mounting plate top surface, wherein the first optical collimator is mounted to a first mounting block.

4. The optical device of claim 2, wherein:
the base plate surface has a first and a second portion;
the first portion is inclined relative to the second portion;
the plurality of mounting plates are mounted to the base plate surface first portion; and
the plurality of support structures are mounted to the base plate surface second portion.

5. The optical device of claim 3, wherein:
each of the mounting blocks includes a hole formed therethrough;
each of the plurality of collimators is disposed inside one of the holes;
the first mounting block includes a first hole formed therethrough; and
the first collimator is disposed inside the first hole.

6. The optical device of claim 1, wherein:
each of the support structures includes a curved upper surface for engaging with the curved surface of one of the first pedestals.

7. The optical device of claim 6, wherein:
each of the support structure curved upper surfaces is a curved annular surface formed about a hole extending into the support structure.

8. The optical device of claim 1, further comprising:
a plurality of second pedestals each having a curved bottom surface mounted over the base plate; and
a plurality of mirrors each mounted to one of the second pedestals for receiving the light beam reflected by one of the optical filters and for reflecting the received light beam to another of the optical filters.

9. The optical device of claim 8, further comprising:
a plurality of curved surface portions formed in the base plate surface each for engaging with one of the second pedestal curved bottom surfaces.

10. The optical device of claim 9, wherein:
each of the curved surface portions is a curved annular surface formed about a hole extending into the base plate.

11. A method of mounting a plurality of mirrors, a plurality of filters and a plurality of collimators having predetermined nominal positions on a base plate to create an optical wavelength multiplexer and de-multiplexer device, the method comprising the steps of:
a) passing light through a first collimator to produce a substantially collimated free-space beam of the light;
b) mounting the first collimator on the base plate so the light beam is directed to a nominal position of one of the mirrors;
c) mounting each of the mirrors onto the base plate for receiving the light beam and for reflecting the light beam to a nominal position of one of the filters;
d) mounting each of the filters onto the base plate for receiving the light beam, for transmitting any portion of the received light beam within a predetermined wavelength range, and for reflecting the untransmitted portion of the received light beam to a nominal position one of the mirrors; and
e) mounting each of the collimators adjacent to one of the mounted filters for receiving the transmitted light beam portion therefrom.

12. The method of claim 11, wherein the mounting of the first collimator includes the steps of:
determining a first target position located beyond an edge of the base plate wherein the light beam from the first collimator passes through both the nominal position of one of the mirrors and the first target position;
positioning an optical detector at the first target position;
moving the first collimator until the detector detects the light beam from the first collimator is centered at the first target position; and
affixing the first collimator onto the base plate.

13. The method of claim 12, wherein the mounting of the first collimator further includes the step of:
inserting a reference flag member between the first collimator and the first target position to block any portion of the beam from the first collimator that is directed below the first target position.

14. The method of claim 12, wherein the mounting of each one of the mirrors includes the steps of:
determining a mirror target position located beyond an edge of the base plate wherein the light beam reflected by the one mirror passes through both the nominal position of one of the filters and the mirror target position;
positioning the optical detector at the mirror target position;
moving the one mirror until the detector detects the light beam reflected by the one mirror is centered at the mirror target position; and
affixing the one mirror onto the base plate.

15. The method of claim 14, wherein the mounting of each one of the filters includes the steps of:
determining a filter target position located beyond an edge of the base plate wherein the light beam reflected by the one filter passes through both the nominal position of one of the mirrors and the filter target position;
positioning the optical detector at the filter target position;
positioning a wavelength detector to receive the portion of the light beam transmitted by the one filter;
moving the one filter until the optical detector detects the light beam reflected by the one filter is centered at the filter target position and the wavelength detector detects the transmitted portion of the light beam has a desired center wavelength; and
affixing the one filter onto the base plate.

16. The method of claim 14, wherein the mounting of each one of the collimators includes the steps of:
moving the one collimator to maximize an amount of the light transmitted by the filter positioned adjacent thereto; and
affix the one collimator onto the base plate.
